(19) United States
(12) Patent Application Publication
(10) Pub. No.: US 2026/0060240 A1
(43) Pub. Date: Mar. 5, 2026

(54) METHOD OF DEPRESSING VOLATILITY OF ORGANIC SOLUTES FROM THEIR AQUEOUS SOLUTIONS

(71) Applicant: Vive Crop Protection Inc., Mississauga (CA)

(72) Inventors: Nikolai Loukine, Toronto (CA); Henry Louis Galas, Mississauga (CA); Jose Amado Dinglasan, Mississauga (CA)

(21) Appl. No.: 19/039,515

(22) Filed: Jan. 28, 2025

Related U.S. Application Data
(60) Provisional application No. 63/689,331, filed on Aug. 30, 2024.
(60) Provisional application No. 63/696,126, filed on Sep. 18, 2024.

(51) Int. Cl. A01N 25/22; A01N 25/06; A01N 37/20; A01N 37/40; A01N 39/04; A01P 13/00; A01P 17/00

(52) U.S. Cl. CPC A01N 25/22; A01N 25/06; A01N 37/20; A01N 37/40; A01N 39/04; A01P 13/00; A01P 17/00

(57) ABSTRACT

The present disclosure relates to a liquid composition, an adjuvant composition, and a concentrate solute composition. The liquid composition comprises an organic solute, a water-immiscible solvent, an aliphatic water-insoluble alcohol, and optionally water. The adjuvant composition comprises a water-immiscible solvent and an aliphatic water-insoluble alcohol. The concentrate solution composition comprises an organic solute, a water-immiscible solvent, and an aliphatic water-insoluble alcohol. The present disclosure relates to a method for suppressing volatility of organic solutes from their aqueous solutions.

### CROSS-REFERENCE TO RELATED APPLICATIONS

This application claims priority from Provisional Application No. 63/689,331, filed Aug. 30, 2024, and Provisional Application No. 63/696,126, filed Sep. 18, 2024, the contents of which are hereby incorporated by reference in their entirety.

### BACKGROUND OF THE INVENTION

The management of volatility in organic solutes from aqueous solutions is critical in various fields, including agriculture, environmental science, chemical engineering, and pharmaceutical development. Volatile organic compounds (VOCs) can pose significant challenges due to their tendency to evaporate into the atmosphere, leading to air quality issues and potential health risks. In particular, organic solutes such as pesticides may drift away from the application site, leading to damage of other crops and other environmental harms. I

Organic solutes often exhibit varying degrees of volatility depending on their molecular structure, functional groups, and the nature of the solvent. When dissolved in water, the interaction between organic molecules and water can significantly influence their vapor pressures. In some cases, high volatility can hinder reaction processes, complicate separation techniques, and complicate regulatory compliance.

Several methods have been explored to reduce the volatility of organic solutes in aqueous solutions. These include modifying the physical and chemical environment of the solutes, employing surfactants, utilizing adsorption techniques, and applying various separation methods such as distillation, membrane processes, and liquid-liquid extraction. Each of these strategies offers unique advantages and challenges, and the choice of method often depends on the specific application, the properties of the solute, and the desired outcome.

Understanding the principles behind volatility reduction is essential for optimizing processes in industries ranging from water treatment to the synthesis of fine chemicals. Moreover, as regulations regarding VOC emissions become increasingly stringent, the development of effective strategies to manage volatility is of paramount importance. This necessitates a comprehensive exploration of innovative methods to depress the volatility of organic solutes, ensuring both environmental protection and economic viability.

### SUMMARY OF THE INVENTION

The present disclosure is directed to a liquid composition. The liquid composition comprises an organic solute, wherein the organic solute comprises an organic compound with a vapor pressure of less than 0.01 mm Hg, a water-immiscible solvent in an amount from about 0.005% to about 5% by weight of the composition, and an aliphatic water-insoluble alcohol.

In some embodiments, the aliphatic water-insoluble alcohol may comprise a primary straight chain alcohol. In some embodiments, the primary straight chain alcohol may comprise a C₁₄-C₁₈ alkanol. In some embodiments, the primary straight chain alcohol is selected from the group consisting of 1-tetradecanol, 1-pentadecanol, 1-hexadecanol, 1-heptadecanol, 1-octadecanol, and combinations thereof.

In some embodiments, the aliphatic water-insoluble alcohol may comprise a 2-(alkyloxy) ethanol, diethylene glycol monoalkyl ethers, triethylene glycol monoalkyl ethers, or combinations thereof. In some embodiments, the 2-(alkyloxy) ethanol is selected from the group consisting of 2-(tetradecyloxy) ethanol, 2-(pentadecyloxy) ethanol, 2-(hexadecyloxy) ethanol, 2-(heptadecyloxy) ethanol, 2-(octadecyloxy) ethanol, and combinations thereof. In some embodiments, the diethylene glycol monoalkyl ether is selected from the group consisting of 2-(2-tetradecyloxyethoxy) ethanol, 2-(2-pentadecyloxyethoxy) ethanol, 2-(2-hexadecyloxyethoxy) ethanol, 2-(2-(heptadecyloxy) ethoxy) ethanol, 2-(2-(octadecyloxy) ethoxy) ethanol, and 2-(2-(cicosanyloxy) ethoxy) ethanol, and combinations thereof. In some embodiments, the tricthylene glycol monoalkyl ether is selected from the group consisting of 2-(2-(2-pentadecyloxyethoxy) ethoxy) ethanol, 2-(2-(2-hexadecyloxyethoxy) ethoxy) ethanol, 2-(2-(2-heptadecyloxyethoxy) ethoxy) ethanol, 2-(2-(2-octadecyloxyethoxy) ethoxy) ethanol, 2-(2-(2-cicosanyloxy) ethoxy) ethoxy) ethanol and combinations thereof.

In some embodiments, the aliphatic water-insoluble alcohol may have a solubility in the water-immiscible solvent of about 4% by weight or greater.

In some embodiments, the water-immiscible solvent may comprise an ester, amide, ether, ketone, alcohol, alkane, alkene, aldehyde or any combination thereof. In some embodiments, the water-immiscible solvent may comprise fatty acid methyl esters, fatty acid ethyl esters, fatty alcohol esters from the group methyl decanoate, octyl acetate, ethyl decanoate, and decyl acetate. In some embodiments, the water-immiscible solvent may have a solubility in water of less than 0.5% by weight.

In some embodiments, the water-immiscible solvent may have a density of less than 1.0 g/cm³. In some embodiments, the water-immiscible solvent may have a boiling point from about 100° C. to about 300° C. at 760 mm Hg.

In some embodiments, a self-assembled monolayer comprising the aliphatic water-insoluble alcohol may be formed on an air/liquid interphase of the liquid composition.

In some embodiments, the organic solute is selected from the group consisting of an auxin herbicide, an insect repellant, an insect pheromone, a fragrance, an essential oil, an insecticide, a fungicide, a carboxylic acid, a phenoxy acid, and any combination thereof. In some embodiments, the auxin herbicide is selected from the group consisting of a natural or synthetic auxin belonging to Group 4 herbicides. In some embodiments, the organic solute is selected from the group consisting of benzoic acid, picolinic acid, a phenoxy acid, and any combination thereof.

In some embodiments, the auxin herbicide may comprise dicamba, triclopyr, 2,4-dichlorophenoxyacetic acid (2,4-D), or a combination thereof. In some embodiments, the insect repellant may comprise N,N-diethyl-meta-toluamide (DEET), icaridin, menthane-3,8-diol, or a combination thereof.

In some embodiments, the water-immiscible solvent may be present in the liquid composition in an amount from about 0.005% to about 5% by weight of the liquid composition. In other embodiments, the water-immiscible solvent may be present in the liquid composition in an amount from about 0.005% to about 0.2% by weight of the liquid composition.

In some embodiments, the liquid composition may further comprise water. The water may be distilled or reverse osmosis-purified water. In some embodiments, the liquid composition may further comprise a water-miscible solvent.

The present disclosure is further directed to an adjuvant composition. The adjuvant composition comprises a water-immiscible solvent; and an aliphatic water-insoluble alcohol. In some embodiments, the aliphatic water-insoluble alcohol may include at least one of a primary straight chain alcohol in an amount not exceeding the primary straight chain alcohol's solubility limit in the water-immiscible solvent, a 2-(alkyloxy) ethanol in an amount not exceeding the 2-(alkyloxy) ethanol's solubility limit in the water-immiscible solvent, a diethylene glycol monoalkyl ether in an amount not exceeding the diethylene monoalkyl ether's solubility limit in the water, or a triethylene glycol monoalkyl ether in an amount not exceeding the triethylene glycol monoalkyl ether's solubility limit in the water. In some embodiments, the aliphatic water-insoluble alcohol may be present in an amount from about 1% to about 50% by weight of the adjuvant composition.

The present disclosure is further directed to a method for reducing the volatility of an organic solute. The method comprises combining an adjuvant composition comprising an aliphatic water-insoluble alcohol and a water-immiscible solvent with a liquid composition comprising the organic solute.

The present disclosure is further directed to a method for reducing vapor drift of an organic solute applied to a crop. The method comprises combining an adjuvant composition comprising an aliphatic water-insoluble alcohol and a water-immiscible solvent with a liquid composition comprising the organic solute and water and spraying the combination onto a crop.

### BRIEF DESCRIPTION OF FIGURES

FIG. 1 is a photograph showing an exposure chamber according to one or more embodiments of the present disclosure.

FIG. 2 is a photograph showing potted dry beans exposed to dicamba acid according to one or more embodiments of the present disclosure.

FIG. 3 is a photograph showing of potted dry beans exposed to dicamba acid according to one or more embodiments of the present disclosure.

FIG. 4 is a photograph showing of potted dry beans exposed to dicamba acid according to one or more embodiments of the present disclosure.

FIG. 5 depicts graphs of raspberry ketone losses (%) vs. evaporation time (h) according to one or more embodiments of the present disclosure.

FIG. 6 depicts graphs of water losses (%) vs. evaporation time (h) according to one or more embodiments of the present disclosure.

FIG. 7 is a plot showing water losses (%) vs. methyl decanoate content (%) according to one or more embodiments of the present disclosure.

FIG. 8 is a plot showing raspberry ketone losses (%) vs. methyl decanoate content (%) according to one or more embodiments of the present disclosure.

FIG. 9 depicts bar plots showing raspberry ketone losses (%) vs. formulations according to one or more embodiments of the present disclosure.

FIG. 10 depicts bar plots showing raspberry ketone losses (%) vs. primary straight chain alcohols according to one or more embodiments of the present disclosure.

FIG. 11 depicts bar plots showing raspberry ketone losses (%) vs. C₁₄ primary straight chain alcohols according to one or more embodiments of the present disclosure.

### DETAILED DESCRIPTION

The present disclosure is directed to a liquid composition. The liquid composition may include an organic solute, a water-immiscible solvent, and an aliphatic water-insoluble alcohol. The liquid composition may be concentrated or may be diluted in a solvent such as water. In agricultural applications, the liquid composition may be suitable for spraying on a plant after dilution when diluted in a solvent such as water.

The liquid composition may comprise an organic solute in an amount from about 30% to about 60% by weight of the liquid composition, a water-miscible solvent in an amount from about 0% to about 25% by weight of the liquid composition, a water-immiscible solvent in an amount from about 0.5% to about 5% by weight of the liquid composition, an aliphatic water-insoluble alcohol in an amount from about 4×10⁻⁴% to about 4% by weight of the liquid composition; and water in an amount from about 0% to about 30% by weight of the liquid composition.

The liquid composition may comprise an organic solute in an amount from about 0.3% to about 0.6% by weight of the liquid composition, a water-miscible solvent in an amount from about 0% to about 0.25% by weight of the liquid composition, a water-immiscible solvent in an amount from about 0.005% to about 0.05% by weight of the liquid composition, an aliphatic water-insoluble alcohol in an amount from about 4×10⁻⁶% to about 0.04% by weight of the liquid composition, and water.

The liquid composition may comprise an organic solute and a water-miscible solvent. The organic solute may comprise an organic compound with a vapor pressure of less than 0.01 mm Hg.

The present disclosure is further directed to an adjuvant composition. The adjuvant composition comprises a water-immiscible solvent and an aliphatic water-insoluble alcohol. The aliphatic water-insoluble alcohol may comprise a primary straight-chain alcohol, 2-(alkyloxy) ethanol, diethylene glycol monoalkyl ether, triethylene glycol monoalkyl ether, or combinations thereof.

The present disclosure is further directed to a concentrated solute composition. The concentrated solute composition comprises an organic solute in an amount no greater than about 60% by weight of the composition, a water-immiscible solvent, and an aliphatic water-insoluble alcohol.

The present disclosure relates to a method for reducing the volatility of an organic solute. The method comprises combining an adjuvant composition comprising an aliphatic water-insoluble alcohol and a water-immiscible solvent with a liquid composition comprising the organic solute.

The present disclosure also relates to a method for preventing the volatilization of an organic solute. The method comprises combining an adjuvant composition comprising an aliphatic water-insoluble alcohol and a water-immiscible solvent with a composition comprising the organic solute, water, and, optionally, a water-miscible solvent. A self-assembled monolayer comprising the aliphatic water-insoluble alcohol may form on an air/water interphase of the liquid composition.

The present disclosure further relates to a method for reducing vapor drift of an organic solute applied to a crop. The method comprises combining an adjuvant composition comprising an aliphatic water-insoluble alcohol and a water-immiscible solvent with a composition comprising the organic solute, water, and, optionally, a water-miscible solvent, and spraying the combination onto a crop.

The present disclosure further relates to a method for reducing drift of an organic solute applied to a crop. The method comprises spraying a liquid composition onto a crop.

The present disclosure also relates to a method of forming a self-assembled monolayer on a water/air interphase of a liquid composition. The method comprises combining an adjuvant composition comprising a water-immiscible solvent and an aliphatic water-insoluble alcohol with a composition comprising an organic solute, water, and, optionally, a water-miscible solvent. The self-assembled monolayer may comprise the primary straight chain alcohol, the 2-(alkyloxy) ethanol, diethylene glycol monoalkyl ethers, triethylene glycol monoalkyl ethers, or a combination thereof.

### I. Liquid Composition

The liquid composition may include an organic solute, a water-immiscible solvent in an amount from about 0.005% to about 5% by weight of the aqueous composition, and an aliphatic water-insoluble alcohol. The organic solute may include an organic compound with a vapor pressure of less than 0.01 mm Hg. The aliphatic water-insoluble alcohol may form a monolayer on the air/liquid interphase of the liquid composition, thereby preventing volatilization of the organic solute.

The aliphatic water-insoluble alcohol may include a primary straight chain alcohol. The primary straight chain alcohol may be a C₁₀-C₂₀ alkanol. For example, the primary straight chain alcohol may be a C₁₀, C₁₁, C₁₂, C₁₃, C₁₄, C₁₅, C₁₆, C₁₇, C₁₈, C₁₉, or C₂₀ alkanol. In some embodiments, the primary straight chain alcohol may be 1-tetradecanol. In some embodiments, the primary straight chain alcohol may be 1-pentadecanol. In some embodiments, the primary straight chain alcohol may be 1-hexadecanol. In some embodiments, the primary straight chain alcohol may be 1-heptadecanol. In some embodiments, the primary straight chain alcohol may be 1-octadecanol. In some embodiments, the primary straight chain alcohol may be 1-tetradecanol, 1-pentadecanol, 1-hexadecanol, 1-heptadecanol, 1-octadecanol, or combinations thereof.

The aliphatic water-insoluble alcohol may be a 2-(alkyloxy) ethanol, diethylene glycol monoalkyl ether, tricthylene glycol monoalkyl ether, or a combination thereof. The 2-alkyloxyethanol may have a C₁₀-C₂₀ alkyl chain. For example, the 2-(alkyloxy) ethanol may be a C₁₀, CH. C₁₂, C₁₃, C₁₄, C₁₅, C₁₆, C₁₇, C₁₈, C₁₉, or C₂₀ alkyloxy. The 2-(alkyloxy) ethanol may be 2-(tetradecyloxy) ethanol, 2-(pentadecyloxy) ethanol, 2-(hexadecyloxy) ethanol, 2-(heptadecyloxy) ethanol, 2-(octadecyloxy) ethanol, or combinations thereof. The diethylene glycol monoalkyl ether may have a C₁₀-C₂₀ alkyl chain. For example, the diethylene glycol monoalkyl ether may be a C₁₀, C₁₁, C₁₂, C₁₃, C₁₄, C₁₅, C₁₆, C₁₇, C₁₈, C₁₉, or C₂₀ alkyloxy. The tricthylene glycol monoalkyl ether may be 2-(2-tetradecyloxyethoxy) ethanol, 2-(2-pentadecyloxyethoxy) ethanol, 2-(2-hexadecyloxyethoxy) ethanol, 2-(2-(heptadecyloxy) ethoxy) ethanol, 2-(2-(octadecyloxy) ethoxy) ethanol, 2-(2-(2-cicosanyloxy) ethoxy) ethoxy) ethanol, or combinations thereof. The triethylene glycol monoalkyl ether may have a C₁₀-C₂₀ alkyl chain. For example, the triethylene glycol monoalkyl ether may be a C₁₀, C₁₁, C₁₂, C₁₃, C₁₄, C₁₅, C₁₆, C₁₇, C₁₈, C₁₉, or C₂₀ alkyloxy. The triethylene glycol monoalkyl ether may be 2-(2-(2-tetradecylethoxyethoxy) ethoxy) ethanol, 2-(2-(2-pentadecyloxyethoxy) ethoxy) ethanol, 2-(2-(2-hexadecyloxyethoxy) ethoxy) ethanol, 2-(2-(2-heptadecyloxyethoxy) ethoxy) ethanol, 2-(2-(2-octadecyloxyethoxy) ethoxy) ethanol, 2-(2-(2-eicosanyloxy) ethoxy) ethoxy) ethanol, or combinations thereof.

The aliphatic water-insoluble alcohol may be present in an amount from about 4×10⁻⁶% to about 4×10⁻²% by weight of the liquid composition. For example, the aliphatic water-insoluble alcohol may range from about 5×10⁻⁶% to about 3×10⁻²%, about 6×10⁻⁶% to about 2×10⁻²%, about 7×10⁻⁶% to about 1×10⁻²%, about 8×10⁻⁶% to about 9×10⁻³%, about 9×10⁻⁶% to about 9×10⁻³%, about 1×10⁻⁵% to about 1×10⁻⁴%, about 2×10⁻⁵% to about 2×10⁻⁴%, about 1×10⁻⁵% to about 1×10⁻⁴%, about 2×10⁻⁵% to about 2×10⁻⁴%, about 3×10⁻⁵% to about 3×10⁻⁴%, about 4×10⁻⁵% to about 4×10⁻⁴%, about 5×10⁻⁵% to about 5×10⁻⁴%, about 6×10⁻⁵% to about 6×10⁻⁴%, about 7×10⁻⁵% to about 7×10⁻⁴%, about 8×10⁻⁵% to about 8×10⁻⁴%, or about 9×10⁻⁵% to about 9×10⁻⁴%.

The water-immiscible solvent may be aliphatic, aromatic, cyclic, or containing hetero atoms including but not limited to Cl, F, N, or S. The water-immiscible solvent may include an ester, amide, ether, ketone, alcohol, alkane, alkene, aldehyde or any combination thereof. The water-immiscible solvent may comprise fatty acid methyl esters, fatty acid ethyl esters, or fatty alcohol esters. The fatty alcohol esters may include methyl decanoate, octyl acetate, ethyl decanoate, or decyl acetate.

The water-immiscible solvent may have a solubility in water of less than 0.5% by weight. For example, the solubility in water may be less than about 0.5%, about 0.4%, about 0.3%, about 0.2%, about 0.1% or about 0.05% by weight. In some embodiments, the water-immiscible solvent mya have a solubility in water of less than 0.2% by weight.

The aliphatic water-insoluble alcohol may have a solubility in the water-immiscible solvent of about 2% by weight or greater. For example, the solubility may be about 2%, about 3%, about 4%, or about 5% by weight or greater.

The water-immiscible solvent may have a density of less than 1.0 g/cm³, such as less than 0.9 g/cm³, less than 0.8 g/cm³, or less than 0.7 g/cm³. For example, the density may be less than 0.99 g/cm³, 0.98 g/cm³, 0.97 g/cm³, 0.96 g/cm³, 0.95 g/cm³, 0.94 g/cm³, 0.93 g/cm³, 0.92 g/cm³, 0.91 g/cm³, 0.90 g/cm³, 0.89 g/cm³, 0.88 g/cm³, 0.87 g/cm³, 0.86 g/cm³, 0.85 g/cm³, 0.84 g/cm³, 0.83 g/cm³, 0.82 g/cm³, 0.81 g/cm³, 0.80 g/cm³, 0.79 g/cm³, 0.78 g/cm³, 0.77 g/cm³, 0.76 g/cm³, 0.75 g/cm³, 0.74 g/cm³, 0.73 g/cm³, 0.72 g/cm³, 0.71 g/cm³, or less than 0.70 g/cm³.

The water-immiscible solvent may have a boiling point from about 100° C. to about 300° C. at 760 mm Hg, such as from about 100° C. to about 150° C., about 100° C. to about 200° C., about 100° C. to about 250° C., about 100° C. to about 300° C., about 150° C. to about 300° C., about 200° C. to about 300° C., or about 250° C. to about 300° C. For example, the boiling point may range from about 110° C. to about 290° C., about 120° C. to about 280° C., about 130° C. to about 270° C., about 140° C. to about 260° C., about 150° C. to about 250° C., about 160° C. to about 240° C., about 170° C. to about 230° C., about 180° C. to about 220° C., about 190° C. to about 210° C., or about 195° C. to about 205° C. at 760 mm Hg. In some embodiments, the water-immiscible solvent may have a boiling point from about 140° C. to about 240° C. at 760 mm Hg.

The organic solute may include an auxin herbicide, an insect repellant, an insect pheromone, a fragrance, an essential oil, an insecticide, a fungicide, a carboxylic acid, a phenoxy acid, or any combination thereof. The auxin herbicide may be a natural or synthetic auxin belonging to Group 4 herbicides. The auxin herbicide may comprise dicamba, triclopyr, 2,4-dichlorophenoxyacetic acid (2,4-D), or a combination thereof. The insect pheromone may comprise alarm pheromones, sex pheromones, trail pheromones, aggregation pheromones, recognition pheromines, or a combination thereof. The insecticides may include but are not limited to pyrethroids, neonicotinoids, organophosphates, biopesticides, or insect growth regulatoes. Examples of pyrethroids include permethrin and cyfluthrin. Examples of neonicotinoids include imidacloprid and clothianidin. Examples of organophosphates include malathion and chlorpyrifos. Examples of biopesticides include Bacillus thuringiensis and neem oil. Examples of insect growth regulators include methoprene and pyriproxyfen. The fungicides include but are not limited to triazoles, biosynthesis inhibitors, contact fungicides, or systemic fungicides. Examples of triazoles include tebuconazole and propiconazole. Examples of biosynthesis inhibitors include chlorothalonil and azoxystrobin. Examples of contact fungicides include copper-based fungicides and sulfur. Examples of systemic fungicides include fluconazole and myclobutanil. The organic solute may be benzoic acid, picolinic acid, a phenoxy acid, or any combination thereof. The insect repellent may include N,N-diethyl-meta-toluamide (DEET), icaridin, menthane-3,8-diol, or a combination thereof. In some embodiments, the organic solute may include a commercially available herbicide.

In some embodiments, the liquid composition may be a heterogeneous solution. For example, the liquid composition may be an emulsion, suspension, slurry, colloid, an aqueous spray mixture, or admixture.

The water-immiscible solvent may be present in the liquid composition in an amount from about 0.005% to about 5% by weight of the liquid composition. For example, the liquid composition may be in an amount from about 0.01% to about 4%, about 0.1% to about 3%, about 0.5% to about 2%, or about 1% to about 1.5% by weight of the liquid composition. In some embodiments, the water-immiscible solvent may be present in the liquid composition in an amount from about 0.005% to about 0.2% by weight of the liquid composition.

In some aspects, the liquid composition may include an organic solute, a water-immiscible solvent in an amount from about 0.005% to about 5% by weight of the aqueous composition, an aliphatic water-insoluble alcohol, and optionally water. The water may be distilled or reverse osmosis-purified water.

The water may have a conductivity of about 0.01 mS/cm or less. For example, the water may have a conductivity of about 0.009 mS/cm or less, about 0.008 mS/cm or less, about 0.007 mS/cm or less, about 0.006 mS/cm or less, about 0.005 mS/cm or less, about 0.004 mS/cm or less, about 0.003 mS/cm or less, about 0.002 mS/cm or less, about 0.001 mS/cm or less, or about 0.0009 mS/cm or less.

In some aspects, the liquid composition may include an organic solute, a water-immiscible solvent in an amount from about 0.005% to about 5% by weight of the aqueous composition, an aliphatic water-insoluble alcohol, and optionally a water-miscible solvent.

The water-miscible solvent may comprise dipropylene glycol, propylene glycol, triethylene glycol, furfuryl alcohol, dimethyl sulfoxide, dimethylformamide, dimethylacetamide, n-methyl-2-pyrrolidone, 1,5-pentanediol, 1,6-hexandiol, sulfolane, or combinations thereof.

In some embodiments, the water-miscible solvent may be miscible with the water-immiscible solvent.

The solubility of the aliphatic water-insoluble alcohol in the water-miscible solvent may be greater than 4%. For example, the solubility may be about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 60%, about 71%, about 72%, about 73%, about 74%, about 75%, about 76%, about 77%, about 78%, about 79%, or about 80%.

The water-miscible solvent may have a boiling point greater than 140° C. For example, the boiling point may be about 140° C., about 145° C., about 150° C., about 155° C., about 160° C., about 165° C., about 170° C., about 175° C., about 180° C., about 185° C., about 190° C., about 195° C., about 200° C., about 210° C., about 220° C., about 230° C., about 240° C., about 250° C., about 260° C., about 270° C., about 280° C., about 290° C., or about 300° C.

The water-immiscible solvent may have a boiling point greater than 140° C. For example, the boiling point may be about 140° C., about 145° C., about 150° C., about 155° C., about 160° C., about 165° C., about 170° C., about 175° C., about 180° C., about 185° C., about 190° C., about 195° C., about 200° C., about 210° C., about 220° C., about 230° C., about 240° C., about 250° C., about 260° C., about 270° C., about 280° C., about 290° C., or about 300° C.

The solubility of the aliphatic water-insoluble alcohol in the water-immiscible solvent may be greater than 4%. For example, the solubility may be about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 60%, about 71%, about 72%, about 73%, about 74%, about 75%, about 76%, about 77%, about 78%, about 79%, or about 80%.

In some aspects, the liquid composition may include an organic solute, a water-immiscible solvent in an amount from about 0.005% to about 5% by weight of the aqueous composition, an aliphatic water-insoluble alcohol, and an amine-based counterion.

In some embodiments, the liquid composition may comprise an organic solute in an amount from about 30% to about 60% by weight of the liquid composition, a water-miscible solvent in an amount from about 0% to about 25% by weight of the liquid composition, a water-immiscible solvent in an amount from about 0.5% to about 5% by weight of the liquid composition, an aliphatic water-insoluble alcohol in an amount from about 4×10⁻⁴% to about 4% by weight of the liquid composition, and water in an amount from about 0% to about 30% by weight of the liquid composition.

The amount of the organic solute in the liquid composition may range from about 30% to about 60%, about 35% to about 55%, or about 40% to about 50% by weight of the liquid composition. The amount of the water-miscible solvent in the liquid composition may range from about 0% to about 25%, about 5% to about 20%, or about 10% to about 15% by weight of the liquid composition. The amount of the water-immiscible solvent in the liquid composition may range from about 0.5% to about 5%, about 1% to about 4%, or about 2% to about 3% by weight of the liquid composition. The amount of the aliphatic water-insoluble alcohol in the liquid composition may range from about 4×10⁻⁴% to about 4%, about 4×10⁻³% to about 3%, about 4×10⁻²% to about 2%, or about 4×10⁻¹% to about 1%, by weight of the liquid composition. The amount of water in the liquid composition may range from about 0% to about 30%, about 5% to about 25%, or about 10% to about 20%.

A self-assembled monolayer comprising the aliphatic water-insoluble alcohol may be formed on an air/water interphase of the liquid composition after dilution by about 100 times with water.

In some embodiments, the liquid composition may comprise an organic solute in an amount from about 0.3% to about 0.6% by weight of the liquid composition, a water-miscible solvent in an amount from about 0% to about 0.25% by weight of the liquid composition, a water-immiscible solvent in an amount from about 0.005% to about 0.05% by weight of the liquid composition; an aliphatic water-insoluble alcohol in an amount from about 4×10⁻⁶% to about 0.04% by weight of the liquid composition, and water.

The amount of the organic solute in the liquid composition may range from about 0.3% to about 0.6%, about 0.35% to about 0.55%, or about 0.4% to about 0.5% by weight of the liquid composition. The amount of the water-miscible solvent in the liquid composition may range from about 0% to about 0.25%, about 0.05% to about 0.20%, or about 0.1% to about 0.15% by weight of the liquid composition. The amount of the water-immiscible solvent in the liquid composition may range from about 0.5% to about 5%, about 1% to about 4%, or about 2% to about 3% by weight of the liquid composition. The amount of the aliphatic water-insoluble alcohol in the liquid composition may range from about 4×10⁻⁶% to about 0.04%, about 4×10⁻⁵% to about 0.03%, about 4×10⁻⁴% to about 0.02%, or about 4×10⁻³% to about 0.01%, by weight of the liquid composition. The amount of water in the liquid composition may range from about 0% to about 30%, about 5% to about 25%, or about 10% to about 20%.

In some aspects, the present disclosure is directed to a liquid composition comprising an organic solute and a water-miscible solvent. The organic solute may be any organic solute described above. Similarly, the water-miscible solvent may be any water-miscible solvent described above.

The water-miscible solvent is present in a concentration from greater than 0% to about 45% by weight. For example, the concentration of water-miscible solvent may range from about 0% to about 45%, about 1% to about 44%, about 2% to about 43%, about 3% to about 42%, about 4% to about 41%, about 5% to about 40%, about 6% to about 39% about 7% to about 38%, about 8% to about 37%, about 9% to about 38%, about 10% to about 37%, about 11% to about 36%, about 12% to about 35%, about 13% to about 34%, about 14% to about 33%, about 15% to about 32%, about 16% to about 31%, about 17% to about 30%, about 18% to about 29%, about 19% to about 28%, about 20% to about 27%, about 21% to about 26%, about 22% to about 25%, or about 23% to about 24%.

### II. Adjuvant

In some aspects, the present disclosure is directed to an adjuvant. The adjuvant composition may be mixed with another composition, such as a commercially available herbicide mixture, to form one or more of the liquid compositions described in Section I. The adjuvant may comprise a water-immiscible solvent and an aliphatic water-insoluble alcohol. The adjuvant composition may be a clear solution.

The aliphatic water-insoluble alcohol may include at least one of a primary straight chain alcohol in an amount not exceeding the primary straight chain alcohol's solubility limit in the water immiscible solvent or a 2-(alkyloxy) ethanol in an amount not exceeding the primary straight chain 2-(alkyloxy) ethanol's solubility limit in the water immiscible solvent. The aliphatic water-insoluble alcohol may include at least one of a primary straight chain alcohol in an amount not exceeding the primary straight chain alcohol's solubility limit in the water immiscible solvent, a 2-(alkyloxy) ethanol, diethylene glycol monoalkyl ether, triethylene glycol monoalkyl ether, or combinations thereof in an amount not exceeding the primary straight chain 2-(alkyloxy) ethanol's, diethylene glycol monoalkyl ether's, and triethylene glycol monoalkyl ether's solubility limit in the water immiscible solvent.

The aliphatic water-insoluble alcohol may be present in an amount from about 1% to about 50% by weight of the adjuvant composition. For example, the aliphatic water-insoluble alcohol may be present in an amount ranging from about 1% to about 50%, about 2% to about 49%, about 3% to about 48%, about 4% to about 47%, about 5% to about 46%, about 6% to about 45%, about 7% to about 44%, about 8% to about 43%, about 9% to about 42%, about 10% to about 41%, about 11% to about 40%, about 12% to about 39%, about 13% to about 38%, about 14% to about 37%, about 15% to about 36%, about 16% to about 35%, about 17% to about 34%, about 18% to about 33%, about 19% to about 32%, about 20% to about 31%, about 21% to about 30%, about 22% to about 29%, about 23% to about 28%, about 24% to about 27%, about 25% to about 26%, about 1% to about 10%, about 1% to about 20%, about 1% to about 30%, about 1% to about 40%, about 1% to about 50%, about 10% to about 50%, about 20% to about 50%, about 30% to about 50%, about 40% to about 50%, about 10% to about 40%, or about 20% to about 30% by weight of the adjuvant composition. In some embodiments, the aliphatic water-insoluble alcohol may be present in an amount from about 10% to about 50% by weight of the adjuvant composition. In some embodiments, the aliphatic water-insoluble alcohol may be present in an amount from about 10% to about 20% by weight of the adjuvant composition.

In some embodiments, the primary straight chain alcohol may comprise a C₁₄-C₁₈ alkanol. The primary straight chain alcohol may be 1-tetradecanol, 1-pentadecanol, 1-hexadecanol, 1-heptadecanol, 1-octadecanol, or combinations thereof.

In some embodiments, the 2-(alkyloxy) ethanol may be 2-(tetradecyloxy) ethanol, 2-(pentadecyloxy) ethanol, 2-(hexadecyloxy) ethanol, 2-(heptadecyloxy) ethanol, 2-(octadecyloxy) ethanol, or combinations thereof.

In some embodiments, the aliphatic water-insoluble alcohol may have a solubility in the water-immiscible solvent of greater than 4%. In some embodiments, the water-immiscible solvent has a solubility in water of less than 0.2%.

In some embodiments, the water-immiscible solvent may have a density of less than 1.0 g/cm³, such as less than 0.9 g/cm³, less than 0.8 g/cm³, or less than 0.7 g/cm³. For example, the density may be less than 0.99 g/cm³, 0.98 g/cm³, 0.97 g/cm³, 0.96 g/cm³, 0.95 g/cm³, 0.94 g/cm³, 0.93 g/cm³, 0.92 g/cm³, 0.91 g/cm³, 0.90 g/cm³, 0.89 g/cm³, 0.88 g/cm³, 0.87 g/cm³, 0.86 g/cm³, 0.85 g/cm³, 0.84 g/cm³, 0.83 g/cm³, 0.82 g/cm³, 0.81 g/cm³, 0.80 g/cm³, 0.79 g/cm³, 0.78 g/cm³, 0.77 g/cm³, 0.76 g/cm³, 0.75 g/cm³, 0.74 g/cm³, 0.73 g/cm³, 0.72 g/cm³, 0.71 g/cm³, or 0.70 g/cm³.

The water-immiscible solvent may have a boiling point from about 100° C. to about 300° C. at 760 mm Hg, such as from about 100° C. to about 150° C., about 100° C. to about 200° C., about 100° C. to about 250° C., about 100° C. to about 300° C., about 150° C. to about 300° C., about 200° C. to about 300° C., or about 250° C. to about 300° C. For example, the boiling point may range from about 110° C. to about 290° C., about 120° C. to about 280° C., about 130° C. to about 270° C., about 140° C. to about 260° C., about 150° C. to about 250° C., about 160° C. to about 240° C., about 170° C. to about 230° C., about 180° C. to about 220° C., about 190° C. to about 210° C., or about 195° C. to about 205° C. at 760 mm Hg. In some embodiments, the water-immiscible solvent may have a boiling point from about 140° C. to about 240° C. at 760 mm Hg.

### III. Concentrated Solute

In some aspects, the present disclosure is directed to a concentrated solute composition. The concentrated solute composition may comprise an organic solute in an amount no greater than about 60% by weight of the composition, a water-immiscible solvent, and an aliphatic water-insoluble alcohol. The organic solute may include any organic solute defined above in Section I.

The aliphatic water-insoluble alcohol may be any aliphatic water-insoluble alcohol described above. The aliphatic water-insoluble alcohol may be present in an amount from about 4×10⁻⁴% to about 4% by weight of the composition. For example, the aliphatic water-insoluble alcohol may be present in an amount from about 4×10⁻⁴% to about 4%, about 5×10⁻⁴% to about 3%, about 6×10⁻⁴% to about 2%, about 7×10⁻⁴% to about 1%, about 8×10⁻⁴% to about 0.5%, about 9×10⁻⁴% to about 0.1%, about 1×10⁻³% to about 9×10⁻²%, about 2×10⁻³% to about 8×10⁻²%, about 3×10⁻³% to about 7×10⁻²%, about 4×10⁻³% to about 6×10⁻²%, about 5×10⁻³% to about 5×10⁻²%, about 6×10⁻³% to about 4×10⁻²%, about 7×10⁻³% to about 3×10⁻²%, about 8×10⁻³% to about 2×10⁻²%, or about 9×10⁻³% to about 1×10⁻²% by weight of the composition.

The aliphatic water-insoluble alcohol may have a solubility in the water-immiscible solvent of greater than 4%. For example, the solubility of aliphatic water-insoluble alcohol in the water-immiscible solvent may be about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 60%, about 71%, about 72%, about 73%, about 74%, about 75%, about 76%, about 77%, about 78%, about 79%, or about 80%.

The water-immiscible solvent may include an ester, amide, ether, ketone, alcohol, alkane, alkene, aldehyde or any combination thereof. The water-immiscible solvent may comprise fatty acid methyl esters, fatty acid ethyl esters, or fatty alcohol esters. The fatty alcohol esters may include methyl decanoate, octyl acetate, ethyl decanoate, or decyl acetate. In some embodiments, the water-immiscible solvent comprises methyl decanoate. In other embodiments, the water-immiscible solvent comprises octyl acetate. In yet other embodiments, the water-immiscible solvent comprises a combination of methyl decanoate and octyl acetate.

In some embodiments, the water-immiscible solvent may have a solubility in water of less than 0.2%. For example, the water-immiscible solvent may have a solubility in water of about 0.2%, about 0.1%, about 0.09%, about 0.08%, about 0.07%, about 0.06%, about 0.05% about 0.04%, about 0.03%, about 0.02%, about 0.01%, about 0.02%, about 0.01%, or about 0%.

In some embodiments, the water-immiscible solvent may have a density of less than 1.0 g/cm³, such as less than 0.9 g/cm³, less than 0.8 g/cm³, or less than 0.7 g/cm³. For example, the density may be less than 0.99 g/cm³, 0.98 g/cm³, 0.97 g/cm³, 0.96 g/cm³, 0.95 g/cm³, 0.94 g/cm³, 0.93 g/cm³, 0.92 g/cm³, 0.91 g/cm³, 0.90 g/cm³, 0.89 g/cm³, 0.88 g/cm³, 0.87 g/cm³, 0.86 g/cm³, 0.85 g/cm³, 0.84 g/cm³, 0.83 g/cm³, 0.82 g/cm³, 0.81 g/cm³, 0.80 g/cm³, 0.79 g/cm³, 0.78 g/cm³, 0.77 g/cm³, 0.76 g/cm³, 0.75 g/cm³, 0.74 g/cm³, 0.73 g/cm³, 0.72 g/cm³, 0.71 g/cm³, or 0.70 g/cm³.

The water-immiscible solvent may have a boiling point from about 100° C. to about 300° C. at 760 mm Hg, such as from about 100° C. to about 150° C., about 100° C. to about 200° C., about 100° C. to about 250° C., about 100° C. to about 300° C., about 150° C. to about 300° C., about 200° C. to about 300° C., or about 250° C. to about 300° C. For example, the boiling point may range from about 110° C. to about 290° C., about 120° C. to about 280° C., about 130° C. to about 270° C., about 140° C. to about 260° C., about 150° C. to about 250° C., about 160° C. to about 240° C., about 170° C. to about 230° C., about 180° C. to about 220° C., about 190° C. to about 210° C., or about 195° C. to about 205° C. at 760 mm Hg. In some embodiments, the water-immiscible solvent may have a boiling point from about 140° C. to about 240° C. at 760 mm Hg.

The concentrated solute composition may further include a water-miscible solvent.

The water-miscible solvent may be present in a concentration from about 0.5% to about 20% by weight of the composition. For example, the water-miscible solvent may be in a concentration of about 0.6% to about 19%, about 0.7% to about 18%, about 0.6% to about 17%, about 0.7% to about 16%, about 0.8% to about 15%, about 0.9% to about 14%, about 1% to about 13%, about 2% to about 12%, about 3% to about 11%, about 4% to about 10%, or about 5% to about 9%, about 6% to about 8% of the composition.

The water-miscible solvent may include dipropylene glycol, propylene glycol, triethylene glycol, furfuryl alcohol, dimethyl sulfoxide, dimethylformamide, dimethylacetamide, n-methyl-2-pyrrolidone, 1,5-pentanediol, 1,6-hexandiol or combinations thereof.

### IV. Method for Reducing Volatility of an Organic Solute

The present disclosure is further directed to a method for reducing the volatility of an organic solute. The method comprises combining an adjuvant composition with a composition comprising an organic solute, water, and, optionally, a water-miscible solvent, to form a liquid composition. The adjuvant composition may be any adjuvant composition described in Section II above. The liquid composition may be any liquid composition described in Section I above.

The method may further comprise diluting the combined adjuvant composition and liquid composition with water by at least 100 times to about 100,000 times. For example, the combined adjuvant composition and liquid composition may be diluted with water by about 100, about 1000, about 10,000, or about 100,000 times. In some embodiments, the water may be distilled or reverse osmosis-purified water. The water may have a conductivity of about 0.01 mS cm⁻¹ or lower.

In some embodiments, combining the adjuvant composition and the liquid composition may form a self-assembled monolayer. The self-assembled monolayer may comprise the aliphatic water-insoluble alcohol on an air/water interphase of the combined adjuvant composition and liquid composition.

The method may further comprise spraying the combined adjuvant composition and liquid composition onto a plant. The plant may be a crop plant, a garden plant, or a wild plant. The plant may include a grass, bush, shrub, tree, flower, root, climber, food crop, feed crop, fiber crop, fuel crop, cash crop, and the like, and any combination thereof.

In some embodiments, the volatility of the organic solute may be reduced as compared to the organic solute dissolved in water alone. In some embodiments, the volatility of the organic solute may be reduced as compared to the organic solute dissolved in a composition consisting of water and the water-miscible solvent.

In some embodiments, the volatility of the organic solute may be reduced by at least 50%. In some embodiments, the volatility of the organic solute may be reduced by at least 60%. In some embodiments, the volatility of the organic solute may be reduced by at least 70%. In some embodiments, the volatility of the organic solute may be reduced by at least 80%. In some embodiments, the volatility of the organic solute may be reduced by at least 90%. In some embodiments, the volatility of the organic solute is reduced by at least 100%.

### V. Method of Preventing the Volatilization of an Organic Solute

The present disclosure is further directed to a method for preventing the volatilization of an organic solute. The method comprises combining an adjuvant composition with a composition comprising an organic solute, water, and, optionally, a water-miscible solvent, to form a liquid composition. The adjuvant composition may be any adjuvant composition described in Section II above. The liquid composition may be any liquid composition described in Section I above. The method may further comprise spraying the combined adjuvant composition and liquid composition onto a plant.

In some embodiments, a self-assembled monolayer comprising the aliphatic water-insoluble alcohol may be formed on an air/water interphase of the liquid composition.

The method may further comprise diluting the combined adjuvant composition and liquid composition with water by at least 100 times to about 100,000 times. For example, the combined adjuvant composition and liquid composition may be diluted with water by about 100, about 1000, about 10,000, or about 100,000 times. In some embodiments, the water may be distilled or reverse osmosis-purified water. The water may have a conductivity of about 0.01 mS cm⁻¹ or lower.

In some embodiments, the volatility of the organic solute may be reduced as compared to the organic solute dissolved in water alone. In some embodiments, the volatility of the organic solute may be reduced as compared to the organic solute dissolved in a composition consisting of water and the water-miscible solvent.

In some embodiments, the volatility of the organic solute may be reduced by at least 50%. In some embodiments, the volatility of the organic solute may be reduced by at least 60%. In some embodiments, the volatility of the organic solute may be reduced by at least 70%. In some embodiments, the volatility of the organic solute may be reduced by at least 80%. In some embodiments, the volatility of the organic solute may be reduced by at least 90%. In some embodiments, the volatility of the organic solute is reduced by at least 100%.

In some embodiments, the liquid composition further comprises a water-miscible solvent.

### VI. Method for Reducing Vapor Drift of an Organic Solute Applied to a Crop

The present disclosure is further directed to a method for reducing vapor drift of an organic solute applied to a crop. The method comprises an adjuvant composition with a composition comprising an organic solute, water, and, optionally, a water-miscible solvent, to form a liquid composition and spraying the combination onto a crop. The adjuvant composition may be any adjuvant composition described in Section II above. The liquid composition may be any liquid composition described in Section I above.

The adjuvant composition may be the adjuvant composition described above. The liquid composition may comprise spraying a liquid composition described above onto a crop.

The spraying may be done in two ways. The spraying may be done by direct spraying on the soil or plants using various sprayer types. Alternatively, the spraying may be done from the air.

Types of spray devices include but are not limited to handheld sprayers, tractor-mounted sprayers, or aerial sprayers. Handheld sprayers may be used for small areas and include backpack and hand-pump sprayers. Tractor-mounted sprayers attach to tractors and may be used for larger fields, offering more efficiency. Aerial sprayers include aircraft or drones equipped for spraying and may be ideal for large or difficult-to-access areas.

### VII. Method for Reducing Drift of an Organic Solute Applied to a Crop

The present disclosure is further directed to a method for reducing drift of an organic solute applied to a crop. The method comprises combining an adjuvant composition with a composition comprising an organic solute, water, and, optionally, a water-miscible solvent, to form a liquid composition and spraying the combination onto a crop. The adjuvant composition may be any adjuvant composition described in Section II above. The liquid composition may be any liquid composition described in Section I above.

The liquid composition may be sprayed in an amount from about 2 to about 20 gallons per acre. For example, the liquid composition may be sprayed in an amount ranging from about 3 to about 19 gallons per acre, about 4 to about 18 gallons per acre, about 5 to about 17 gallons per acre, about 6 to about 16 gallons per acre, about 7 to about 15 gallons per acre, about 8 to about 14 gallons per acre, about 9 to about 13 gallons per acre, or about 10 to about 12 gallons per acre.

### VIII. Method of Forming a Self-Assembled Monolayer on Water/Air

The present disclosure is further directed to a method of forming a self-assembled monolayer on a water/air interphase of a liquid composition. The method comprises combining an adjuvant composition with an aqueous composition comprising an organic solute to form a liquid composition. The adjuvant composition may be any adjuvant composition described in Section II above. The liquid composition may be any liquid composition described in Section I above.

The self-assembled monolayer may comprise the aliphatic water-insoluble alcohol.

### Definitions

Unless otherwise defined, all technical and scientific terms used herein have the same meaning as is commonly understood by one of skill in the art to which this invention belongs at the time of filing. If specifically defined, then the definition provided herein takes precedent over any dictionary or extrinsic definition. Further, unless otherwise required by context, singular terms shall include pluralities, and plural terms shall include the singular. Herein, the use of “or” means “and/or” unless stated otherwise. All patents and publications referred to herein are incorporated by reference.

As used herein, the terms “about” and “approximately” designate that a value is within a statistically meaningful range. Such a range can be typically within 10%, more typically still within 7%, and even more typically within 5% of a given value or range. The allowable variation encompassed by the terms “about” and “approximately” depends on the particular system under study and can be readily appreciated by one of ordinary skill in the art.

When introducing elements of aspects of the invention or the embodiments thereof, the articles “a,” “an,” “the,” and “said” are intended to mean that there are one or more of the elements, and thus may include plural referents unless the context clearly dictates otherwise. The terms “comprising,” “including,” and “having” are intended to be inclusive and mean that there may be additional elements other than the listed elements.

As used herein, the word “exemplary” means serving as an example, instance, or illustration. The aspects described herein are not limiting but rather are exemplary only. It should be understood that the described aspects are not necessarily to be construed as preferred or advantageous over other aspects. Unless otherwise indicated, no aspect of any invention described herein should be assumed to have the same advantages or features had by any other aspect.

As used herein, the term “organic solute” refers to substances that are composed of carbon and are soluble in a solvent, typically water or organic solvents like alcohols, ethers, or hydrocarbons. Organic solutes may include an isolated organic solute or a commercially available formulation including an organic solute as an active ingredient. As used herein, the phrase “wt % of organic solute” refers to wt % of the active ingredient(s) of the commercial formulation. By way of a non-limiting example, a liquid composition that includes 10 wt % of a commercially available formulation of 5 wt % dicamba would be said to include 0.5 wt % of an organic solute.

Having described aspects of the invention in detail, it will be apparent that modifications and variations are possible without departing from the scope of aspects of the invention as defined in the appended claims. As various changes could be made in the above compositions, products, and methods without departing from the scope of aspects of the invention, it is intended that all matter contained in the above description shall be interpreted as illustrative and not in a limiting sense.

While the foregoing description makes reference to particular illustrative embodiments, these examples should not be construed as limitations. The inventive system, methods, and products can be adapted for other uses or provided in other forms not explicitly listed above, and can be modified in numerous ways within the spirit of the present disclosure. Thus, the present invention is not limited to the disclosed embodiments, but is to be accorded the widest scope consistent with the claims below.

### Examples

Examples have been set forth below for the purpose of illustration and to describe certain specific embodiments of the disclosure. However, the scope of the claims is not to be in any way limited by the examples set forth herein. Various changes and modifications to the disclosed embodiments will be apparent to those skilled in the art and such changes and modifications including, without limitation, those relating to the chemical structures, substituents, derivatives, formulations, or methods of the disclosure may be made without departing from the spirit of the disclosure and the scope of the appended claims. Definitions of the variables in the structures in the schemes herein are commensurate with those of corresponding positions in the formulae presented herein.

### First Generation of Dicamba Formulation (Batch #90)

The first generation of dicamba formulations (Batch #90) contained 48.38 wt. % dicamba acid, 15.5 wt. % oligomeric polyethyleneimine, 4×10⁻⁴ wt. % 1-hexadecanol, 20 wt. % dipropylene glycol, and water to balance. The formulation was clear yellowish viscous solution, but still pourable, and was fully miscible with water resulting in a clear solution. When concentration of 1-hexadecanol in the formulations exceeded 8×10 3 wt. %, the alcohol aggregated and precipitated when the formulations were 100 times diluted with water. The addition of dipropylene glycol made the hexadecanol fully soluble in the formulation and made the formulation resistant to any phase transitions up to −18° C.

### Dicamba Formulations

The volatility of dicamba cannot be determined by the HPLC because of its extremely low concentration in the air. A method was developed to monitor the volatility of the dicamba in a specially designed exposure chamber. Live potted plants were kept as “sensors” in the exposure chamber.

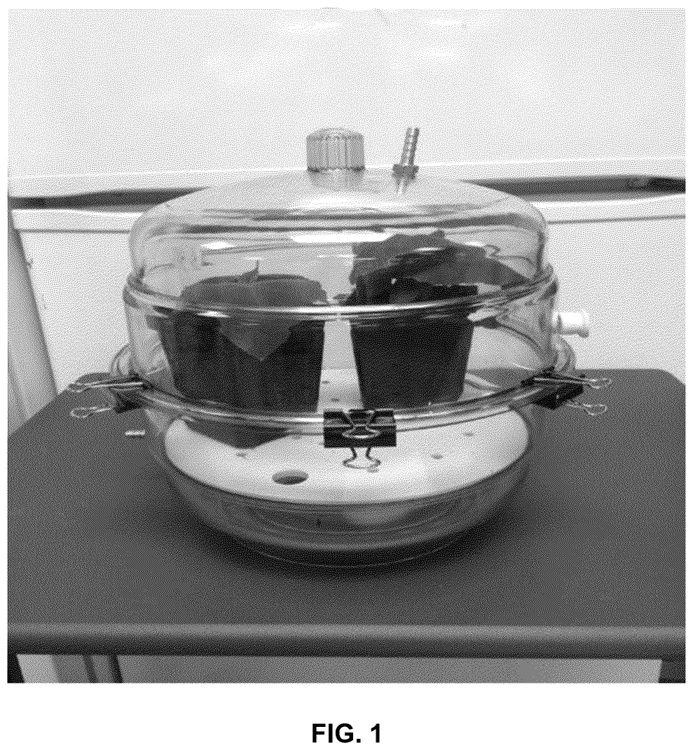

FIG. 1 shows the exposure chamber. The chamber was a desiccator made from a clear acrylate plastic fitted with an air inlet and outlet. The inlet was in the bottom part of the desiccator. The incoming air blew on the surface of an aqueous dicamba solution (100.00 g) in a plastic petri dish. Two to three live potted dry beans were kept on a perforated support just above the petri dish. The air exited the chamber through a vent at the top of the upper part of the desiccator. The two parts of the desiccator were secured with an O-ring and six paper clips to avoid air losses through the joint. To intensify the dicamba vapor drifts the extra dry air was purged with the flow rate of 1 ft³/hr. Three to four desiccators were used to verify the reproducibility and/or try different formulations in the same run. The desiccators were kept in a growing chamber maintained at 30° C. The experiments continued for 24 to 48 hours to induce the damage to the plants due to exposure to dicamba vapors. The damage included leaf cupping, stem twisting, and retarded growths. The petri dishes with dicamba solutions were weighed before and after exposure to monitor the water evaporation.

Initially, only commercial formulations were tested to determine what rate of dilutions of these formulations are needed to have any noticeable injuries due to exposure to dicamba vapors. The commercial formulations used were Dicamba HD (Albaugh, Inc./Agri Star), Engenia (BASF) and XtendiMax (Bayer).

It was determined that at 10,000 ppm dicamba acid only Dicamba HD injured the plants. At 20,000 ppm dicamba acid the injuries from Dicamba HD became more severe. XtendiMax at this level also induced substantial damage to the plants, but less than Dicamba HD. The plants exposed to Engenia were only slightly injured. Thus, formulation Engenia was the preferred formulation and used as a control to compare the disclosed formulations.

Seventeen experiments were run to compare test formulations to the commercial formulations and verify their reproducibility. The test formulations tested are shown in Table 1 below.

TABLE 1
Test formulations with varying amounts of dicamba
acid, oligomeric polyethyleneimine, and water.

| | | | | Oligomeric | |
|---|---|---|---|---|---|
| | Dicamba | 1-hexa- | Dipropylene | polyethyl- | |
| Formu- | acid | decanol | glycol | eneimine | Water |
| lation | (wt. %) | (wt. %) | (wt. %) | (wt. %) | (wt. %) |
| Batch #90 | 48.38 | 4 × 10⁻⁴ | 20 | 15.5 | 16.12 |
| Batch #89 | 60 | 4 × 10⁻⁴ | 20 | 19 | 0.99 |

The experiments were performed at 40,000 ppm dicamba acid in dilutions for better discrimination between the formulations. Batch #90, which included 1-hexadecanol and dipropylene glycol, outperformed Engenia in these comparisons. Surprisingly formulation Batch #89, which contained 60 wt. % dicamba acid, 19 wt. % oligomeric polyethyleneimine, 4×10⁻⁴ wt. % 1-hexadecanol, 20 wt. % dipropylene glycol, and water to balance, was also very promising.

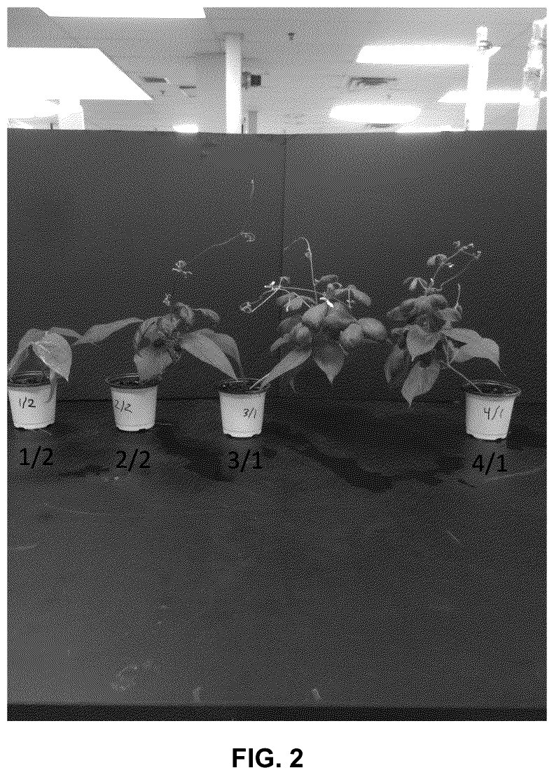

The images of potted dry beans exposed to 40,000 ppm dicamba acid in dilutions for 48 hours to XtendiMax, Engenia, Batch #89 and Batch #90 are shown in FIG. 2. The pictures were taken at 14 DAT. After the exposure first plant from the left, ½, treated with XtendiMax completely stopped growing and showed necrosis on the leaves. The second one, 2/2, treated with Engenia revealed necrosis on the tips of top trifoliate (visible with zooming) and did not produce new trifoliates above the damaged ones. Plants 3/1 (Batch #90 with molecular drift deterrent) and 4/1 (Batch #89 without the deterrent) not only developed new trifoliates above the exposed ones but also started blooming. Notably there was no visible necrosis on the exposed leaves, only cupping. Of dry beans 3/1 and 4/1, the 3/1 set was slightly less damaged and looked healthier.

From the effect on the plants as explained above, the introduction into dicamba formulations of hexadecanol and dipropylene glycol resulted in formulations with decreased dicamba volatilization. But the effect was not very drastic. The rate of water evaporation from petri dishes was statistically more or less the same in all dilutions implying that the monomolecular barrier on surfaces of Batch #90 dilutions, if formed, was not perfect. More formulations with dicamba, oligomeric polyethyleneimine, dipropylene glycol, 1-hexadecanol, other solvents, and water were prepared and tested. The dicamba formulations and their properties are described in Examples 1-5.

### Example 1: Dicamba Formulation Containing 1-Hexadecanol and Dipropylene Glycol (Water Miscible Solvent)

Formulation Batch #84 (Table 2), containing 50 wt. % dicamba acid, 16 wt. % oligomeric polyethyleneimine, 20 wt. % dipropylene glycol, 4×10⁻⁴ wt. % 1-hexadecanol, and water to balance, and commercial dicamba formulation Engenia (BASF) were diluted with RO water to 40,000 ppm dicamba acid. The dilutions (100.00±0.01 g each) were poured into plastic petri dishes of 13.5 cm diameter. The filled dishes were placed into two exposure chambers. Both chambers then were loaded with potted dry beans, two plants in each chamber. The exposure of plants to dicamba vapor drifts continued for 27 hours with extra dry air flow of 1 cubic foot per hour. The exposure chambers were kept in a growing station lit by led lights and maintained at 30° C. After the exposure the plants were kept in a greenhouse, where they were inspected for the injuries induced by the exposure to dicamba vapors 9 and 17 DATs.

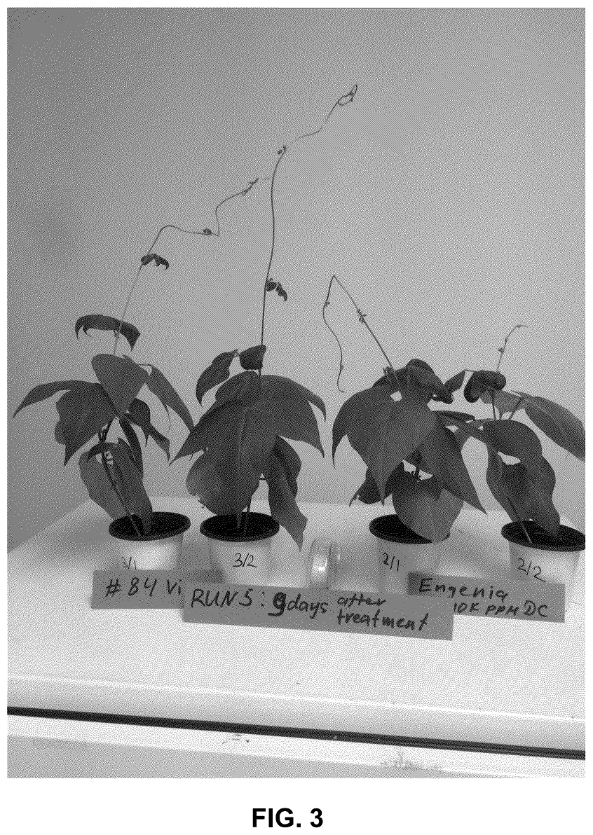

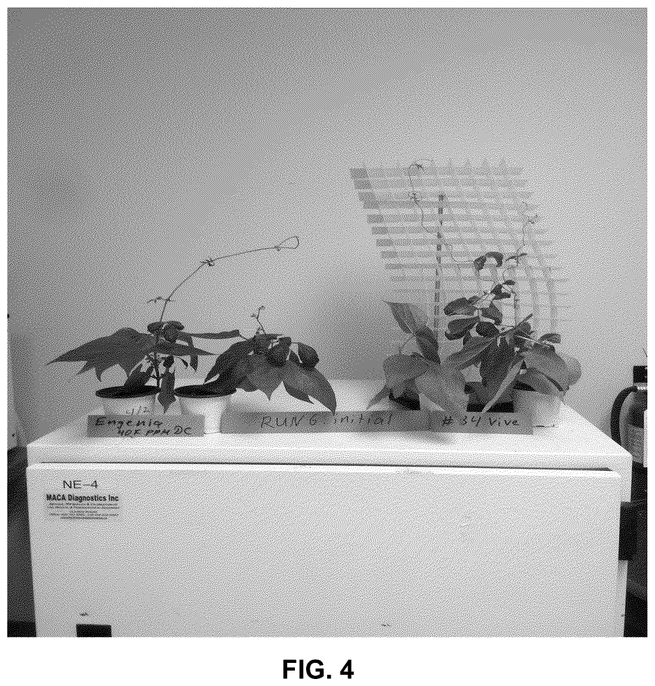

The pictures of the exposed dry beans are in FIG. 3 and FIG. 4. FIG. 3 shows dry beans exposed to dicamba vapor drifts from aqueous dilutions of Batch #84 and Engenia formulations 9 DATs. FIG. 4 shows dry beans exposed to dicamba vapor drifts aqueous dilutions of Batch #84 and Engenia formulations 17 DATs.

TABLE 2
Dicamba aqueous formulation - Batch #84

| | | | | Oligomeric | |
|---|---|---|---|---|---|
| | Dicamba | 1-hexa- | Dipropylene | polyethyl- | |
| Formu- | acid | decanol | glycol | eneimine | Water |
| lation | (wt. %) | (wt. %) | (wt. %) | (wt. %) | (wt. %) |
| Batch #84 | 50 | 4 × 10⁻⁴ | 20 | 16 | 14 |

Nine days after treatment both plants exposed to aqueous Engenia showed obvious cupping of upper trifoliates and absence of new trifoliates on growing stems. The dry beans treated with aqueous Batch #84 almost did not have cupped trifoliates and both growing stems, were at least two times longer than the ones with plants treated with Engenia, had new small trifoliates.

Seventeen days after treatment the dry beans exposed to Engenia looked like ones after 9 DATs, i.e. they stopped growing. The new stems of the other two plants, exposed to Batch #84, continued growing. They became so long that a support—a divider from a case of glass scintillation bottles—was installed behind to prop up such long stems. One of these plants also started blooming, which could be seem when the imaged was zoomed in.

Leave cupping and suppression of the plant growth are typical effects, when plants are exposed to volatilized dicamba. The results confirmed that the technique to retard volatilization of dicamba acid from its aqueous solutions worked since the plants detected it.

Example 1 shows that dicamba composition containing 1-hexadecanol and water miscible solvent, dipropylene glycol, induced lesser damage on live dry beans than similarly diluted commercial dicamba composition Engenia.

### Example 2: Dicamba Formulation Containing 1-Hexadecanol, Dipropylene Glycol (Water Miscible Solvent), and n-Octyl Acetate (Water Immiscible Solvent)

Dicamba aqueous formulations Batch #99, containing 48.38 wt. % dicamba acid, 15.5 wt. % oligomeric polyethyleneimine, 4×10⁻⁴ wt. % hexadecanol, 20 wt. % dipropylene glycol, 2 wt. % n-octyl acetate and water to balance, and Batch #90, containing 48.38 wt. % dicamba acid, 15.5 wt. % oligomeric polyethyleneimine, 4×10⁻⁴ wt. % hexadecanol, 20 wt. % dipropylene glycol and water to balance, were diluted 100 times with RO-water. The dilutions were poured, as duplicates, into glass petri dishes (9.5 cm diameter), 50.00±0.01 g per dish. The petri dishes were randomly arranged in a fume hood and kept there exposed to air flow of 4 km/h at ambient conditions. After 24 hours exposure all four petri dishes were removed, and the dishes were weighed to measure water losses. It was revealed that water losses in Batch #99 duplicate were 51.4%, the average of 51.7 and 51.1, and in Batch #90 duplicate they were 79.7%, the average of 76.7 and 82.6. The reproducibility in both duplicates, especially the first one, was rather good. The introduction of 2% water-immiscible solvent, i.e. n-octyl acetate, into the formulation helped to decrease the water losses by almost 30%. In other words, the addition of the solvent resulted in more efficient evaporation barrier on the dilution interphase.

Batch #99 outperformed Batch #90 in terms of dicamba volatility. But in Batch #90 formulation the dicamba was already less volatile than the herbicide in the two most advanced commercial dicamba formulations on the market now as described above.

TABLE 3
Dicamba aqueous formulations - with and without n-octyl acetate

| | Dicamba | | Dipropylene | Oligomeric | n-octyl | |
|---|---|---|---|---|---|---|
| | acid | 1-hexadecanol | glycol | polyethyleneimine | acetate | Water |
| Formulation | (wt. %) | (wt. %) | (wt. %) | (wt. %) | (wt. %) | (wt. %) |
| Batch #99 | 48.38 | 4 × 10⁻⁴ | 20 | 15.5 | 2 | 14.11 |
| Batch #90 | 48.38 | 4 × 10⁻⁴ | 20 | 15.5 | 0 | 16.11 |

Example 2 shows that incorporation of water-immiscible solvent, octyl acetate, into a dicamba composition resulted in almost 36% decrease in the rate of water evaporation.

### Example 3: Addition of Disclosed Adjuvants to Commercial Dicamba Formulations

Two aqueous dilutions of commercial formulation XtendiMax (containing 29.0 wt. % dicamba acid) were prepared. Each dilution contained 6,000 ppm dicamba acid.

For the first control dilution (dilution 1) the formulation (2.277 g) was mixed with RO-water (107.723 g). It was a clear blueish solution.

The second dilution (dilution 2) was produced by mixing the XtendiMax (2.277 g) with RO-water (106.623 g) and an adjuvant (1.1 g). The adjuvant was a clear solution of 6.5 wt. % 1-octanol and 0.04 wt. % 1-hexadecanol in dipropylene glycol. This mixture was homogenized by 1 min of shaking resulting in a fine stable emulsion.

Both dilutions were poured, as duplicates, into glass petri dishes (9.5 cm diameter), 50.00±0.01 g per dish. The petri dishes were randomly arranged in a fume hood and exposed to air flow of 4 km/h at ambient conditions. After 20 hours exposure all four petri dishes were removed and the dishes were weighed to measure water losses. Water losses in the duplicate of dilution 2 were 55.5%, the average of 54.8% and 57.0%, and in the dilution 1 duplicate they were 90.1%, the average of 88.6% and 91.6%. The addition of the adjuvant decreased the rate of water evaporation by 34.6%. Consequently, the volatilization of dicamba acid from sprays of dilution 2 also should be suppressed as compared to the control dilution.

Example 3 shows that mixing commercial dicamba composition XtendiMax with disclosed adjuvant, a dipropylene glycol solution containing 6.5 wt. % 1-octanol and 0.04 wt. % 1-hexadecanol decreased the rate of water evaporation by 38.4%.

### Example 4: Formulations Prepared with RO-Purified Water and Tap Water

Two aqueous dilutions of commercial formulation XtendiMax were prepared at 6,000 ppm dicamba acid each. Both dilutions also contained 1 wt. % of an adjuvant, a clear solution of 1 wt. % methyl decanoate and 0.04 wt. % 1-hexadecanol in dipropylene glycol, and water to balance.

The first dilution (dilution 1) was made with RO-water and the second dilution (dilution 2) contained tap water. Both mixtures were homogenized by 1 min shaking resulting in fine stable emulsions. The dilutions were poured, as duplicates, into glass petri dishes (9.5 cm diameter), 50.00±0.01 g per dish. The petri dishes were randomly arranged in a fume hood and exposed to air flow of 4 km/h at ambient conditions. After 20 hours exposure all four petri dishes were removed and the dishes were weighed to measure water losses. Water losses in the duplicate of dilution 1 were 64.9%, the average of 63.9 and 65.9, and in the dilution 2 duplicate they were 82.2%, the average of 83.4 and 82.2. The dilutions with RO-water demonstrated a lower water evaporation rate.

Example 4 shows rate of water evaporation from aqueous dicamba compositions were lower in RO-purified water than tap water by 21%.

### Alternatives to Dicamba Acid

To further improve the barrier action of long chain primary alkanols, substrates other than dicamba were tested. Dicamba acid has a very low vapor pressure of 3.4×10⁻⁵ mmHg. A search was performed to find a substrate with a higher vapor pressure. The search resulted in a fragrance, raspberry ketone, 4-(4-hydroxyphenyl)-2-butanonem with a vapor pressure of between 1-3×10⁻³ mmHg, i.e. 100 times higher than dicamba.

Next formulations similar to Batch #90, containing raspberry ketone instead of dicamba, were made. Evaporation experiments were conducted on the dilutions and the concentrations were monitored by HPLC. This revealed the small but quantitative losses of raspberry ketone during the evaporation experiments. It appeared that the introduction of hexadecanol and dipropylene glycol did not influence on the volatility of the raspberry ketone.

A quantitative HPLC-based method was developed and used to monitor volatility of the organic substrate from its aqueous solutions but did not get the evidence that 1-hexadecanol retards its volatilization. While making formulations, it was hypothesized that when the formulations are diluted with water, 1-hexadecanol may find its way to the surface of the solution and may form there a monomolecular monolayer. The monomolecular monolayer may be formed on a small scale, considering how live plants reacted on the exposure to Batch #90, but the barrier is patchy.

When a formulation containing 1-hexadecanol is diluted with water, the portion of hexadecanol above its solubility limit of 40 ppb has three options. The options are: 1) stick to the walls of a container; 2) aggregate in the bulk of the dilution and then move to the surface; and/or 3) stay in the bulk of the liquid phase or migrate to the surface as single molecules and form a monomolecular layer. To get a better barrier, the first two options must be suppressed.

Next, the effect of adding a volatile water-immiscible liquid with less density than water and that is a good solvent for the chosen alcohol to the formulation was tested. One can expect that some amounts of 1-hexadecanol molecules or its aggregates leave the water phase and enter the microdroplets of this organic solvent. The 1-hexadecanol may also stabilize these microdroplets preventing them from fast coalescing. These microdroplets with the dissolved alcohol, being less dense than water, may migrate to the surface of the aqueous phase. The solvent may evaporate, releasing 1-hexadecanol just where it is needed, i.e. on the interphase, to build a volatilization barrier.

In the next series of experiments, multiple water-immiscible solvents were tested such as cyclohexane, n-amyl acetate, n-octyl acetate, methyl decanoate, 2-decanone, 1-octanol, n-dodecane, and n-hexadecane. The solvents were added to formulations of raspberry ketone. The volatilization was measured by HPLC.

Formulations were prepared containing 0.5 wt. % raspberry ketone, 4×10⁻⁴ wt. % to 4×10⁻² wt. % 1-hexadecanol, different amounts of above mentioned solvents and dipropylene glycol to balance. If the amounts of solvents were below their solubility limits, or emulsions, clear formulations were diluted 100 times with water resulting in clear dilutions. The dilutions (13.000±0.001 g) were poured into aluminum trays (ca. 5 cm dia.) and the trays were arranged in the fume hood exposed to the air flow of 4 km/h velocity at ambient conditions. Each dilution was tried as a duplicate or triplicate. In control trays similar formulations, but without the solvents, were poured. The evaporation experiments continued for 20-24 hours. The trays were weighed before and after the evaporation runs and weight losses, due to mostly water evaporation, were recorded. The solutions in trays after the tests were transferred into 20 mL scintillation glass vials and together with initial solutions/emulsions were submitted to the HPLC analysis for the raspberry ketone content.

HPLC analysis revealed that the approach to add water-immiscible solvents into formulations worked in reducing the rate of volatilizing raspberry ketone. Notably, in some experiments, the rate of volatilizing raspberry ketone in the presence of the solvents decreased by a factor of 10.

The following aspects/details were revealed through these experiments. There is an optimal concentration of the solvents in formulations to get the most profound effect. For practically insoluble solvents such as methyl decanoate, dodecane, hexadecane and cyclohexane it is 1.0 wt. % in the formulation, which results in 0.01 wt. % in the aqueous dilutions. The content of these solvents in aqueous dilutions is way over their solubility limits. For solvents having solubility in water above 0.01 wt. % the optimal concentration in the formulations is 2 wt. % for n-octyl acetate, 3 wt. % for 2-octanone, 5 wt. % for 1-octanol, and 20 wt. % for amil acetate, which are at or slightly above their solubility limits in water when the formulations diluted 100 times with water. Below these optimal concentrations the effect of decreasing solute volatility drops. Above these optimal concentrations the effect still exists but is not reproducible: half dilutions have the same retarding effect as at optimal concentrations and in another haff dilutions the solutes evaporate much faster than at optimal concentrations. The dilutions, containing too much solvent, are not stable and incline towards fast separation. That may be the reason for the non-reproducibility.

The results also showed that volatilization rate of raspberry ketone decreases with the increase in 1-hexadecanol content in formulations. Consequently, most of the experiments were performed with formulations containing 4×10⁻² wt. % of the alcohol which is close to its acceptable limit. When 1-hexadecanol concentration in formulations containing water-immiscible solvents are above 0.2 wt. % the alcohol aggregates fast when formulations diluted 100 times with water. It is worth noting that without solvent the aggregation of hexadecanol starts at 0.08 wt. % in formulations when they diluted in a similar way. This effect can be attributed to dissolving some hexadecanol in emulsified solvents.

Not all solvents that were tried are feasible to be used in practice. For example, cyclohexane is very flammable and cannot be kept in plastic containers, which limits its use. Also, amyl acetate's optimal concentration in formulation is 20 wt. %, which is too much for formulating dicamba.

The decrease in raspberry ketone volatilization is also accompanied by decrease in water evaporation. Water losses in control experiments, i.e. formulations without solvents, were about 70 wt. % and the losses in dilutions with organic solvents were in the range of 45-55 wt. %, depending on type of solvent following 20 h exposure in the fume hood. The losses of water always correlated with raspberry ketone volatilization: the less solute volatilization is observed in formulations with the lesser water evaporation rate.

It was confirmed that addition into formulations a combination of 1-hexadecanol and specific amounts of water-immiscible organic liquids delays volatilization of solutes when the formulations are diluted with water. This effect was quantitatively verified with aqueous solutions of raspberry ketone. It was interesting to see if this effect exists with more volatile solutes. To find this out the following solutes with different vapor pressures and boiling points were formulated using a combination of 1-hexadecanol and methyl decanoate: DEET insecticide (N,N-diethyl-3-methylbenzamide), p-methoxyphenol, 2-phenylethyl acetate. The formulations contained 0.5 wt. % of each solute, 0.04 wt. % 1-hexadecanol, 1 wt. % methyl decanoate and dipropylene glycol to balance. The control formulations included 0.5 wt. % of each solute, 0.04 wt. % 1-hexadecanol and dipropylene glycol to balance. The evaporation experiments were run as described above. The results of these experiments and some properties of the solutes are in Table 4.

TABLE 4
Volatilization of different solutes from their
aqueous solutions measured by HPLC (initial amount
of solute in each experiment was 0.65 mg)

| | Solute losses, | | Ratio of no | Solute properties | |
|---|---|---|---|---|---|
| | mg × 10³ | | solvent/with | | Vapor |
| | No | With | solvent losses, | b.p., | pressure, |
| Solute | solvent | solvent | mg/mg | ° C. | mmHg |
| Raspberry ketone | 12 | 2 | 6 | 292 | 1 × 10⁻³ |
| DEET | 23 | 14 | 1.6 | 290 | 5 × 10⁻³ |
| p-methoxyphenol | 45 | 40 | 1.3 | 253 | 7 × 10⁻³ |
| 2-phenylethyl | 650 | 650 | 1 | 239 | 0.06 |
| acetate | | | | | |
| acetophenone | 650 | 650 | 1 | 202 | 0.39 |

As seen in Table 4 above, based on the vapor pressure, DEET is 5 times more volatile than raspberry ketone. Consequently it was not surprising to see larger volatilization rates of this solute relative to the raspberry ketone. The decrease in efficacy of methyl decanoate in building the monomolecular layer of 1-hexadecanol molecules on the surface of dilutions is surprising. The ratio of solute losses without the solvent and with solvent dropped almost 4 times as compared to the raspberry ketone. This tendency continued with p-methoxyphenol, which is slightly more volatile than DEET. The volatility of this solute increased again from both dilutions, i.e. without and with methyl decanoate, but the ratio dropped even lower, to 1.3 mg/mg. And finally, both the more volatile solvents, 2-phenylethyl acetate and acetophenone, fully evaporated from both solutions during 20 h exposure. A similar pattern was also observed with water evaporation. From these data it was concluded that the solute delayed volatilization in presence 1-hexadecanol and water-immiscible organic solvents is limited to solutes with vapor pressure below 0.01 mmHg or boiling points above 250° C. at 760 mmHg. The are quite a lot of organic solutes that fit such requirements.

The dilution of a clear formulation, containing 0.5 wt. % solute, 1 wt. % water-immiscible solvent, 0.04 wt. % 1-hexadecanol and dipropylene glycol to balance, with water results in a rather stable fine aqueous emulsion, where oil microdroplets presumably contain the hexadecanol. But when this homogeneous formulation, which contains about 99 wt. % water-miscible dipropylene glycol, is stirred into water not all hexadecanol is loaded fast into the oil phase. It needed time for the alcohol molecules to dissolve in the aqueous phase and then migrate into the microdroplets. That was likely the reason for some non-reproducibility in duplicates and triplicates of experiments.

Next, a solution of 1-hexadecanol by itself was added to a water-immiscible liquid (without dipropylene glycol) to a solute aqueous solution. In this approach the resulting emulsion was predicted to contain almost all hexadecanol loaded into oil microdroplets. In this technique the process of delaying volatilization of solutes from their aqueous solutions consists of mixing two-components: an adjuvant, a solution of primary long chain alcohol in a water-immiscible solvent, and an aqueous organic solute. When these two components are combined all long chain alcohol, being in oil microdroplets, will propel straight to the interphase and build the needed volatilization deterrent.

The maximum solubility of 1-hexadecanol in dipropylene glycol is ca. 4.0 wt. % at 22° C. It was determined that solubility of 1-tetradecanol, 1-hexadecanol and 1-octadecanol in methyl decanoate at the same temperature was 22 wt. %, 8 wt. % and 4 wt. % respectively. If this adjuvant is a 4 wt. % 1-hexadecanol in the solvent it should be diluted 10,000 times with an aqueous phase to get similar levels of the alcohol and the methyl decanoate as 100 times diluted formulations in the one-component approach. The primary alcohols with longer chains such as 1-cicosane and 1-docosane appeared to have too low solubility in water-immiscible organic solvents to be effective in helping to form monomolecular barriers.

The new technique to use adjuvants, the C₁₄-C₁₈ primary alcohols in water-immiscible organic solvents, was verified in the following two experiments. In both experiments the raspberry ketone was used as a solute. The adjuvant in the first experiment was 4 wt. % 1-hexadecanol in methyl decanoate. The dilution was prepared by dispersing 0.01 g of the adjuvant in 99.99 g of 0.005 wt. % aqueous raspberry ketone (10,000 dilution). The mixture obtained was shaken by hand for 2 min and the resultant fine emulsion was poured in 15 aluminum trays (ca. 5 cm dia), 7.000 g per tray. The trays were randomly arranged in a fume hood and kept there exposed to air flow of 4 km/h at ambient conditions. After 1, 2, 3, 4 and 5 hours exposure all trays were removed, three at each time set, to have triplicates. The trays were weighed to measure water losses and aliquots from each tray were submitted to the HPLC analysis for the raspberry ketone content. A second control experiment was performed in a similar way with 15 trays filled with 0.005 wt. % aqueous raspberry ketone.

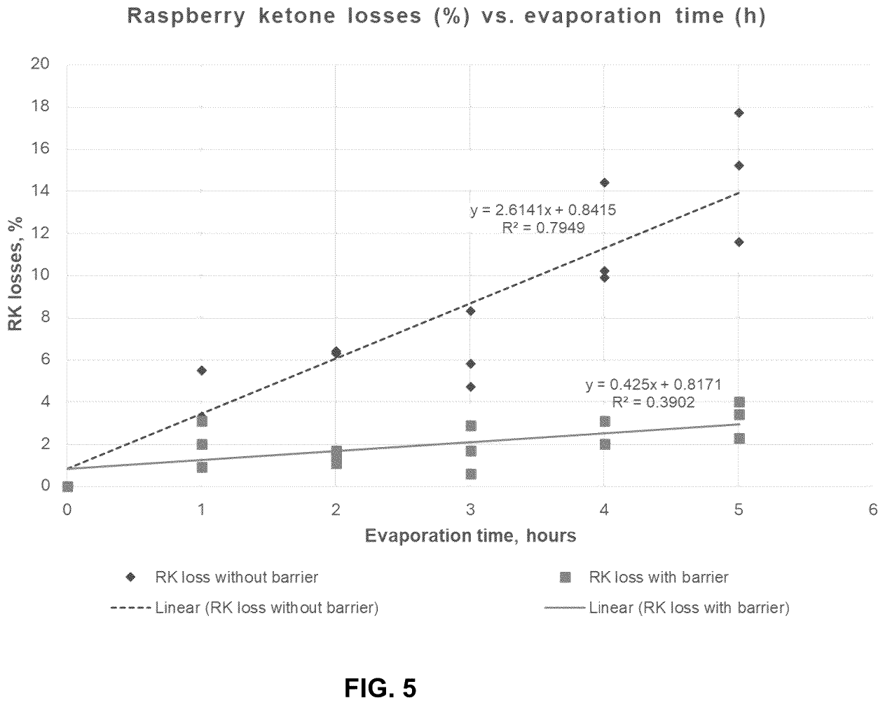

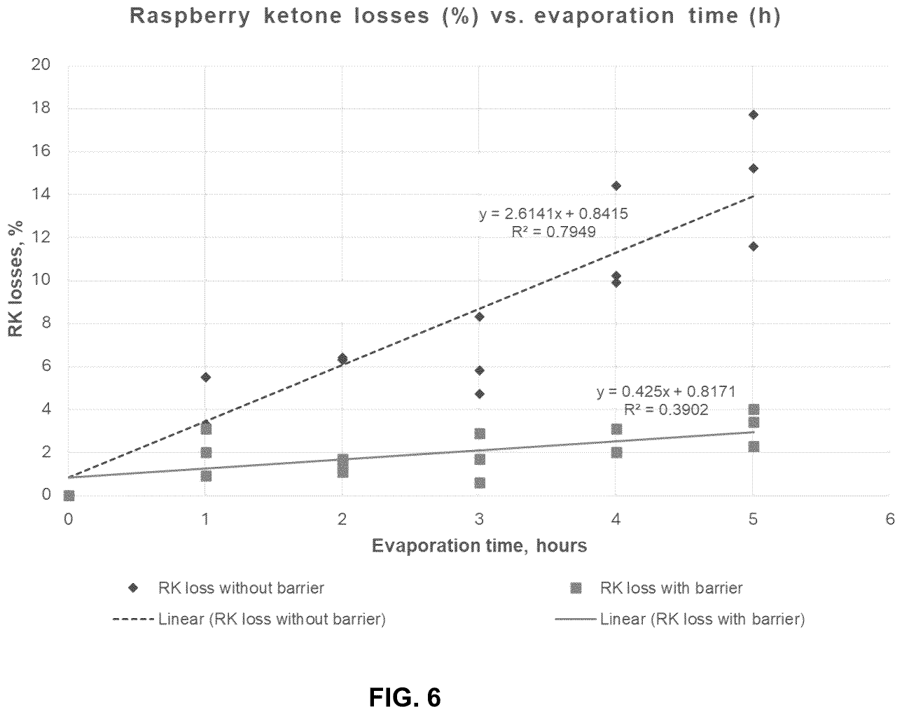

The kinetics of raspberry ketone and water losses are shown in FIG. 5 and FIG. 6 respectively. As seen from FIG. 5, in the presence of the barrier formed of 1-hexadecanol molecules, the ketone volatility dropped 6 times. The barrier also resulted in a 3 times lower rate of water evaporation, which is not surprising. In both experiments the reproducibility in triplicates was rather good. The only triplicate, where a set of data was out of range, was one with raspberry ketone losses without the barrier at 3 hours evaporation point. It is worth noting that the non-reproducibility was witnessed quite often with solute volatilization without barriers. That is why triplicates and in some cases pentaplicated were run in cases of uncertainty.

Multiple experiments on volatilization of solutes from their aqueous dilutions in the presence of the adjuvants were performed with different primary long-chain alcohols and water-immiscible solvents and solutes. The results were similar: the addition of solutions of primary C₁₄-C₁₆ straight chain alcohols in water-immiscible solvents suppressed the volatilization of the solute and this effect was more reproducible as compared to formulations containing combinations of water-miscible and water-immiscible solvents.

Experiments on volatilization of raspberry ketone from its aqueous emulsions, produced by 10,000 times dilution of 0.01 g 2 wt. %, 4 wt. %, 6 wt. %, and 8% wt. % 1-hexadecanol in methyl decanoate with 0.005 wt. % raspberry ketone in RO-water revealed that ketone losses were statistically the same with adjuvants containing 4 wt. %, 6 wt. %, and 8 wt. % of the alcohol. In the dilutions of the adjuvant with 2 wt. % 1-hexadecanol the ketone losses were about 25% higher. Related experiments with the adjuvant, containing 4 wt. %, 8 wt. %, 12 wt. %, 16 wt. %, and 22 wt. % 1-tetradecanol in methyl decanoate, gave a similar outcome. In aqueous dilutions of adjuvants containing 8-22 wt. % 1-tetradecanol in methyl decanoate the raspberry ketone losses were on par, about two times less than with adjuvant containing 4% tetradecanol in the solvent. These results are not surprising. The surface of dilutions in aluminum trays was about 19 cm² and the depth of the dilutions was 3 mm. So, when the amounts of the alcohols are enough to completely cover the interphase, the extra alcohol influenced the solute volatilization. But when the surface of interphase is increased, especially when dilutions are sprayed resulting in large surface as compared to the depth, the ability to increase concentrations of the alcohols in the adjuvants became an important issue.

Four adjuvants containing 4 wt. % 1-tetradecanol, 1-hexadecanol, 1-octadecanol and 1-iccosanol, 0.01 g each were diluted to 100.00 g with 0.005 wt. % raspberry ketone in methyl decanoate. The evaporation tests of the dilutions (6.00 g per tray, 4 hours at air velocity of 4 km/h) resulted in raspberry ketone losses, wt. %, of 7.2, 2.6, 5.5 and 8.4 respectively. The efficacy of 1-tetradecanol can be increased to 1-hexadecanol level by doubling its concentration in the adjuvant. The efficacy of 1-octadecanol cannot be improved since even at 4% concentration in methyl decanoate it starts precipitating. 1-Eicosanol is already oversaturated at 4% level and adjuvant had to be added heated to 50° C. to have a clear solution.

While running multiple experiments on solute's volatilization and water evaporation an interesting and, to some extent, surprising effect was revealed: both water and solutes disappeared faster when solutes were dissolves in reverse osmosis water (RO-water) than tap water. For example, the ratio of water evaporation rate from 0.05% raspberry ketone in tap water to water evaporation in RO water, wt./wt., was 1.2 and the similar ratio for raspberry ketone was 1.8. In other words, the raspberry ketone losses from its solution in tap water were 80% bigger than the ones from RO-water. This effect should be taken into account when preparing sprays for auxin herbicides, considering that portable reverse osmosis set-ups are quite affordable now.

### Example 5: Formulations of Raspberry Ketone with Varying Amounts of Water-Immiscible Solvent (Methyl Decanoate) and Raspberry Ketone Volatility

Five formulations of raspberry ketone were prepared. All were clear solutions containing 0.5 wt. % raspberry ketone, 0.04 wt. % 1-hexadecanol, varying amounts of methyl decanoate, and dipropylene glycol to balance. The amount of methyl decanoate varied from 0 wt. %, 0.25 wt. %, 0.5 wt. %, 1.0 wt. % and 2.0 wt. %.

The formulations were diluted 100 times with RO-water and produced mixtures were shaken by hand resulting in fine stable emulsions. The dilutions (13.000±0.001 g) were poured into aluminum trays (ca. 5 cm dia.) and the trays were arranged in the fume hood and exposed to the air flow of 4 km/h velocity at ambient conditions. Each dilution was tried as a quadruplicate. The evaporation experiments continued for 22 hours. The trays were weighed before and after the evaporation run and weight losses, due to mostly water evaporation, were recorded. The solutions in trays after the tests were transferred into 20 mL scintillation glass vials and were submitted to the HPLC analysis for the raspberry ketone content.

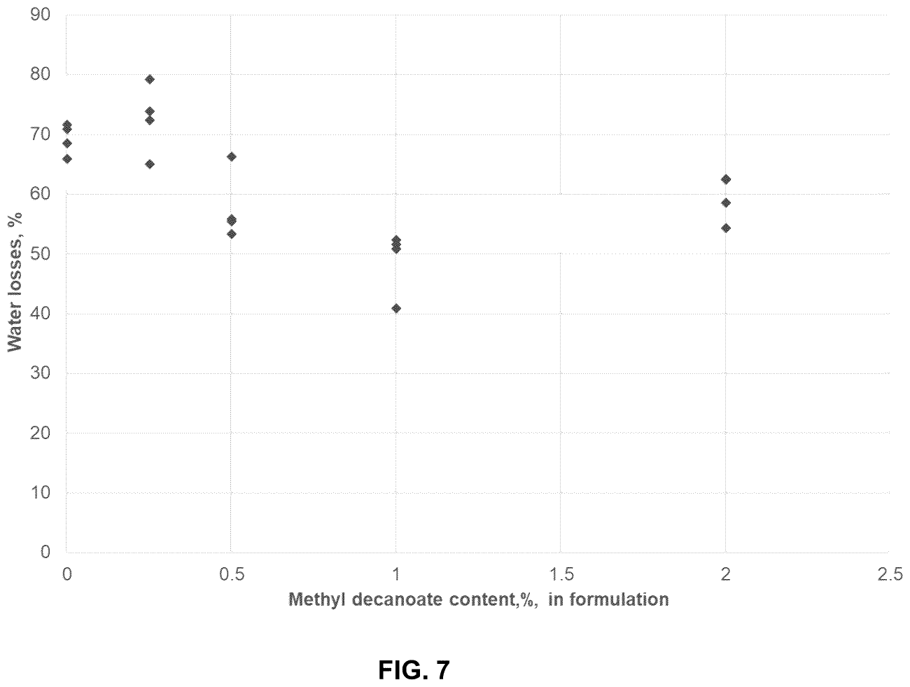

The water losses are shown in FIG. 7. The graph shows that the addition of 0.25 wt. % methyl decanoate into the formulation did not change significantly the water evaporation rate. The evaporation even intensified a little. The drop in water losses started at 0.5 wt. % methyl decanoate and became more profound at 1.0 wt. % content. When concentration of the solvent in formulation became 2.0 wt. % the water losses again intensified.

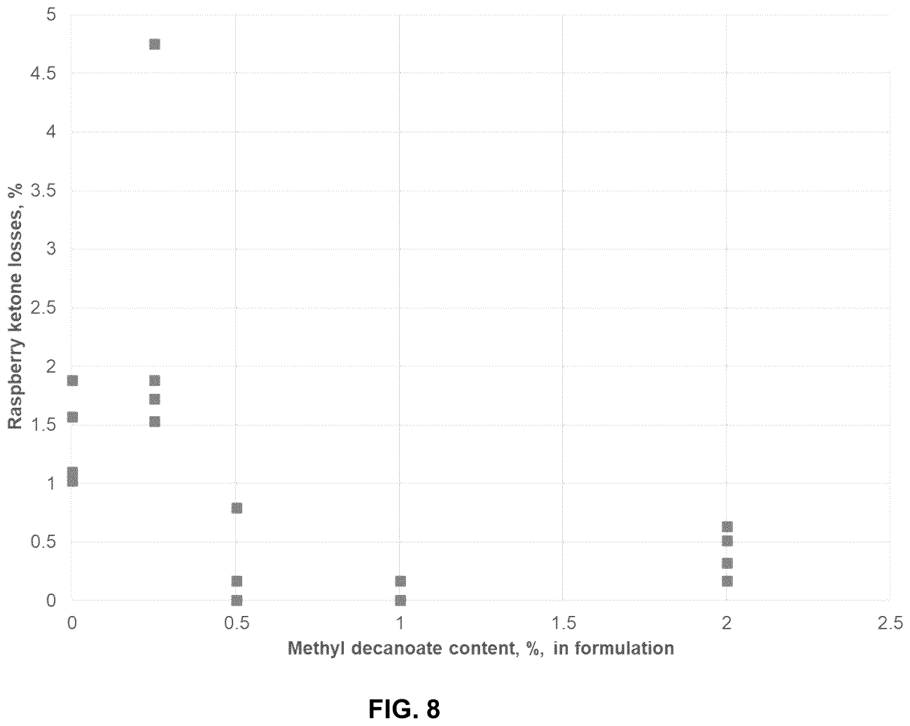

A similar trend as seen in water losses was seen with raspberry ketone losses (FIG. 8). The minimal ketone losses were registered at 1.0 wt. % methyl decanoate in the formulation. At 1.0 wt. % level in the formulation the methyl decanoate content in the dilution was 0.01%, which is about 25 times higher than the solubility of the solvent in water. The same behavior, i.e. minimal solute volatilization from its aqueous dilutions at specific solvent concentrations, was observed with other water-immiscible solvents. With solvents like methyl decanoate, i.e. practically insoluble in water, this “sweet spot” was also 1 wt. % in formulations. Notably, solvents more soluble in water had higher optimal concentrations in formulations. For example, 2 wt. % for octyl acetate, 3 wt. % for 2-decanone, 5 wt. % to 6.5 wt. % for 1-octanol, 12 wt. % for 2-octanone, and 20 wt. % for amyl acetate.

When concentrated compositions of the raspberry ketone contained 0 wt. %, 0.5 wt. %, 1.0 wt. % and 2.0 wt. % methyl decanoate (water immiscible solvent) and the same amounts of 1-hexadecanol (0.04 wt. %) (barrier), the losses of the ketone due to volatilization were 1.39 wt. %, 0.24 wt. %, 0.04 wt. % and 0.41 wt. % respectively. Before testing on volatilization these concentrated compositions were diluted 100 times with water. The purpose for the use of water-miscible solvent, dipropylene glycol, was to have the concentrated compositions homogeneous and stable. When diluted with water these compositions converted into fine emulsions, which were stable enough to be handled. The water-miscible solvent does not influence the volatility of organic solutes, but the water-immiscible solvent does.

### Example 6: Formulations of Raspberry Ketone with Four Different Water-Immiscible Solvents And Raspberry Ketone Volatility

As shown in Table 5, five formulations of raspberry ketone were prepared. All were clear solutions containing 0.5 wt. % raspberry ketone and 0.04 wt. % 1-hexadecanol. Formulation RK #28 did not include a water-immiscible solvent. The other four formulations contained the following water-immiscible solvents: 2 wt. % n-octyl acetate (RK #29), 5 wt. % 1-octanol (RK #35), 1 wt. % methyl decanoate (RK #43) and 3 wt. % 2-decanone (RK #51). The dipropylene glycol was added to balance in these four formulations. All formulations were diluted 100 times with RO-water.

TABLE 5
Formulations of raspberry ketone with four
different water-immiscible solvents.

| | | | | Water- |
|---|---|---|---|---|
| | Raspberry | 1- | Dipropylene | immiscible |
| | ketone | hexadecanol | glycol | solvent |
| Formulation | (wt. %) | (wt. %) | (wt. %) | (amount) |
| RK#28 | 0.5 | 0.04 | 99.46 | — |
| RK#29 | 0.5 | 0.04 | 97.46 | n-octyl acetate |
| | | | | 2 wt. % |
| RK#35 | 0.5 | 0.04 | 94.46 | 1-octanol |
| | | | | 5 wt. % |
| RK#43 | 0.5 | 0.04 | 98.46 | methyl decanoate |
| | | | | 1 wt. % |
| RK#51 | 0.5 | 0.04 | 96.46 | 2-decanone |
| | | | | 3 wt. % |

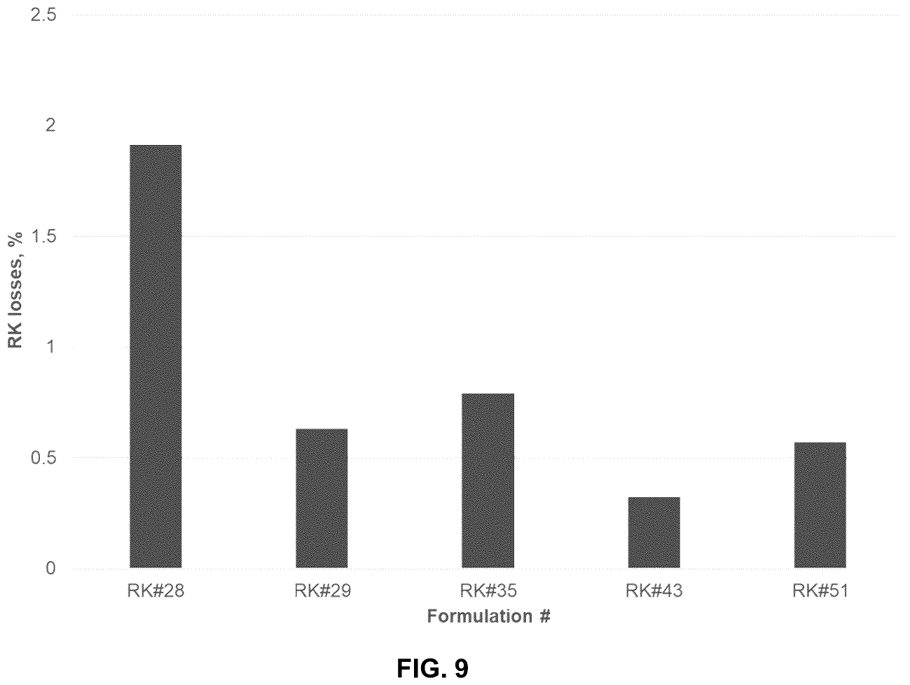

The contents of the water-immiscible solvents were their concentrations, where minimal evaporation rates of the solute from its aqueous dilutions was detected. The formulations were diluted 100 times with RO-water and produced mixtures were shaken by hand resulting in fine stable emulsions. The dilutions (13.000±0.001 g) were poured into aluminum trays (ca. 5 cm dia.) and the trays were arranged in the fume hood and exposed to the air flow of 4 km/h velocity at ambient conditions. Each dilution was tried as a duplicate. The evaporation experiments continued for 22 hours. The trays were weighed before and after the evaporation run and weight losses, due to mostly water evaporation, were recorded. The solutions in trays after the tests were transferred into 20 mL scintillation glass vials and were submitted to the HPLC analysis for the raspberry ketone content. The raspberry ketone losses are shown in FIG. 9. These data are the averages of the duplicates. The data in all duplicates were very close.

The dilutions of all formulations containing water-immiscible solvents have lower volatilization rate of raspberry ketone than the dilution based on RK #28, which contains only raspberry ketone, 1-hexadecanol and dipropylene glycol. The dilutions of formulation RK #43, containing 1 wt. % methyl decanoate, shows the lowest volatilization rate of the solute. As usual water losses followed the solute losses, the lowest losses were for RK #43, which were 47 wt. %, and the highest ones were for RK #28, which were 69 wt. %.

In Example 6, four water-immiscible solvents, two esters, n-octyl acetate and methyl decanoate, a ketone (2-decanone) and an alcohol (1-octanol) were compared (all solvents are water immiscible). The raspberry ketone losses due to its volatilization were 1.91% in a control experiment (no water-immiscible solvent), 0.32% (with 1 wt. % methyl decanoate in the concentrate), 0.63% (with 2.0 wt. % n-octyl acetate in the concentrate), 0.57% (with 3 wt. % 2-decanone in the concentrate) and 0.79% (with 5 wt. % 1-octanol in the concentrate). The contents of the water-immiscible solvents in the concentrates were their concentrations, where minimal evaporation rates of the raspberry ketone from its aqueous dilutions were experimentally detected.

### Example 7: Formulations of Raspberry Ketone Prepared with Tap Water

Formulation RK #43, containing 0.5 wt. % raspberry ketone, 0.04 wt. % 1-hexadecanol, 1 wt. % methyl decanoate and dipropylene glycol to balance, was diluted 100 times with tap and RO-water and produced mixtures were shaken by hand resulting in fine stable emulsions. The dilutions (17.000±0.001 g) were poured into aluminum trays (ca. 5 cm dia.) and the trays were arranged in the fume hood and exposed to the air flow of 4 km/h velocity at ambient conditions. Each dilution was tried as a triplicate. The evaporation experiments continued for 20 hours. The trays were weighed before and after the evaporation run and weight losses, due to mostly water evaporation, were recorded. The solutions in trays after the tests were transferred into 20 mL scintillation glass vials and were submitted to the HPLC analysis for the raspberry ketone content. The raspberry ketone losses from dilutions in RO-water were 0.91±0.18% and in tap water were 1.63±0.07%. The water losses were 35.1±1.5% from dilutions in RO water and 43.0±0.8% from dilutions from tap water.

Example 7 shows that decreases in raspberry ketone (solute) volatilization and water evaporation were larger from dilutions in tap water than in RO-purified water.

### Example 8: DEET Formulations with Water-Immiscible Solvent (Methyl Decanoate) and Water Losses from Aqueous Solutions

Two formulations of DEET (N,N-diethyl-3-methylbenzamide) were prepared. Formulation DEET1 contained 0.5 wt. % DEET, 0.04 wt. % 1-hexadecanol and dipropylene glycol to balance. Formulation DEET2 included 0.5 wt. % DEET, 0.04 wt. % 1-hexadecanol, 1 wt. % methyl decanoate and dipropylene glycol to balance. The formulations were diluted 100 times with RO-water and produced mixtures were shaken by hand resulting in a clear solution with DEET1 and a fine stable emulsion with DEET2. The dilutions (13.000±0.001 g) were poured into aluminum trays (ca. 5 cm dia.) and the trays were arranged in the fume hood and exposed to the air flow of 4 km/h velocity at ambient conditions. Each dilution was tried as a duplicate. The evaporation experiments continued for 19 hours. The trays were weighed before and after the evaporation run and weight losses, due to mostly water evaporation, were recorded. The solutions in trays after the tests were transferred into 20 mL scintillation glass vials and were submitted to the HPLC analysis for the raspberry ketone content. The data in all duplicates were very close. The average DEET losses in wt. %, were 3.5% for DEET1 and 2.2% for DEET2. The water losses were 44% (DEET1) and 36% (DEET2). So, the effect is similar to the one with raspberry ketone formulations but with higher losses of the solute and much lesser differences in both solute and water losses with and without methyl decanoate.

### Example 9: Adjuvant in Raspberry Ketone Formulation

An adjuvant, 4.0 wt. % 1-hexadecanol in methyl decanoate, was diluted 10,000 times, by weight, with 0.005 wt. % raspberry ketone in RO-water. The dilution was shaken by hand resulting in a fine stable emulsion. The dilution along with a control, 0.005 wt. % raspberry ketone in RO-water, were poured into aluminum trays (ca. 5 cm dia.), 7.000±0.001 g per tray and the trays were arranged in the fume hood and exposed to the air flow of 4 km/h velocity at ambient conditions. Each dilution was tried as a triplicate. The evaporation experiments continued for 5 hours. The trays were weighed before and after the evaporation run and weight losses, due to mostly water evaporation, were recorded. The solutions in trays after the tests were transferred into 20 mL scintillation glass vials and were submitted to the HPLC analysis for the raspberry ketone content. The raspberry ketone losses were 3.2±0.9% from dilutions with 1-hexadecanol and methyl decanoate and 14.8±3.1% from the control, 0.005% raspberry ketone in RO-water. The water losses were 26.3±1.3% from dilutions with 1-hexadecanol and methyl decanoate and 77.5±6.1% from 0.005 wt. % aqueous raspberry ketone.

Example 9 shows that emulsions of an adjuvant, 4 wt. % hexadecanol in methyl decanoate, in an aqueous solution of 0.005 wt. % raspberry ketone had lesser both the solute and water volatilization than the 0.005 wt. % aqueous raspberry ketone by itself.

### Example 10: Adjuvants of Four Different Primary Alcohols at the Same Concentration in Raspberry Ketone

Four adjuvants were prepared containing 4.0 wt. % 1-tetradecanol, 4.0 wt. % 1-hexadecanol, 4.0 wt. % 1-octadecanol and 4.0 wt. % 1-eicosanol in methyl decanoate. The adjuvants had aliphatic tails. The aliphatic tails protruded into air (above the surface of water) should assemble as tight as possible to provide a good barrier for water molecules. Branching and presence of cycles in the adjuvants would interfere with forming such tightly assembled monolayers. Less tightly packed monolayers will be formed with branched and cyclic variants and result in defects in the monolayer. These defects in the barrier monolayer will be the “gates” for water molecules to evaporate.

The solutions of the first two alcohols were clear liquids. The 1-octadecanol at this concentration was very close to its solubility limit at room temperature. The 4 wt. % 1-cicosanol was way above its solubility limit at 22° C. but the alcohol dissolved fully at temperatures above 40° C. and did not crystallize for quite a long time at the room temperature being oversaturated.

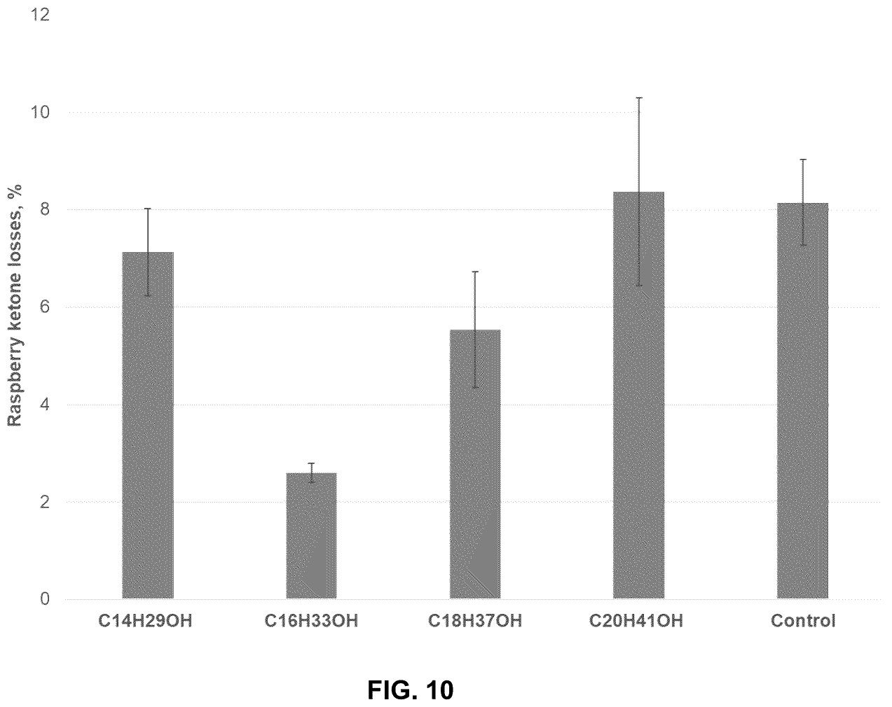

The adjuvants were diluted 10,000 times, by weight, with 0.005 wt. % raspberry ketone in RO-water. The dilutions were shaken by hand resulting in fine stable emulsions. The control was 0.005 wt. % raspberry ketone in RO-water. The emulsions along with a control, 0.005 wt. % aqueous raspberry ketone, were poured into aluminum trays (ca. 5 cm dia.), 6.000±0.001 g per tray and the trays were arranged in the fume hood and exposed to the air flow of 4 km/h velocity at ambient conditions. Each dilution was tried as a triplicate. The evaporation experiments continued for 4 hours. The trays were weighed before and after the evaporation run and weight losses, due to mostly water evaporation, were recorded. The solutions in trays after the tests were transferred into 20 mL scintillation glass vials and were submitted to the HPLC analysis for the raspberry ketone content. The raspberry ketone losses are shown in FIG. 10.

It appeared that 1-eicosanol did not retard the volatilization of the solute. The most profound delays in volatilization of raspberry ketone were observed with 1-hexadecanol followed by 1-octadecanol and 1-tetradecanol. The concentrations of 1-tetradecanol and 1-hexadecanol in methyl decanoate can be increased to 22% (for C₁₄H₂₉OH) and to 8 wt. % (for C₁₆H₃₃OH). One might expect that at higher concentrations of these alkanols the rate of the solute volatilization could be even lower.

It was found that C₁₄, C₁₆ and Cis performed better than C₂₀. Eicosanol also has too low solubility in water-immiscible solvents. C₁₂ alcohol is a liquid and would have a much higher solubility in water and would also have a lower boiling point than C₁₄-C₁₈ alcohols.

### Example 11. Adjuvants of 2 Different Primary Alcohols at Higher Concentrations in Raspberry Ketone

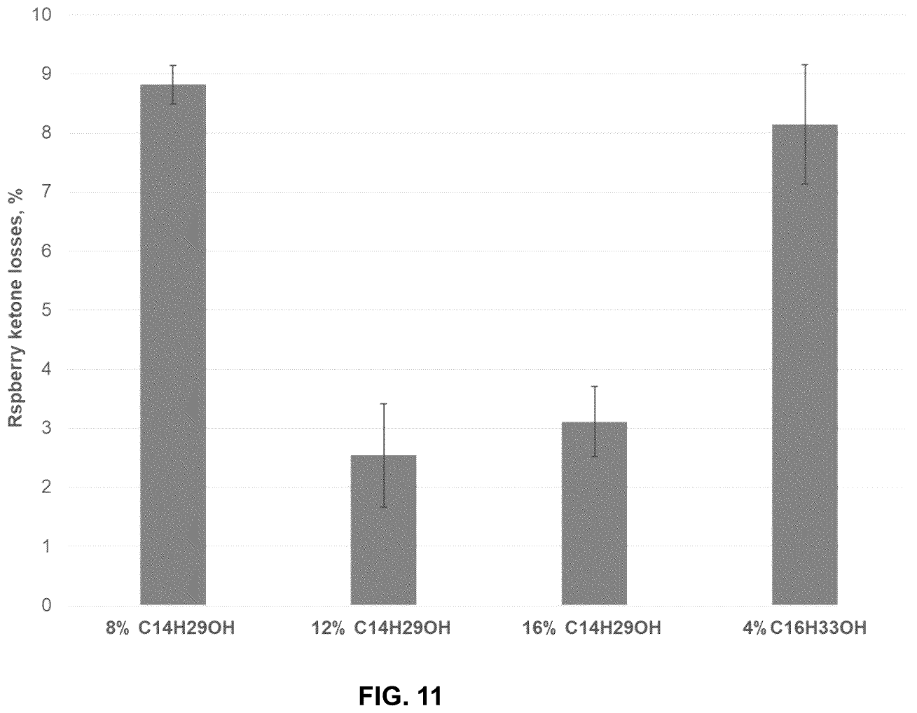

Four adjuvants were prepared containing 8 wt. %, 12 wt. % and 16 wt. % 1-tetradecanol and 4 wt. % 1-hexadecanol in methyl decanoate. All adjuvants were clear liquids. The adjuvants were diluted 10,000 times, by weight, with 0.005% raspberry ketone in RO-water. The dilutions were shaken by hand resulting in fine stable emulsions. The emulsions were poured into aluminum trays (ca. 5 cm dia.), 6.000±0.001 g per tray and the trays were arranged in the fume hood and exposed to the air flow of 4 km/h velocity at ambient conditions. Each dilution was tried as a triplicate. The evaporation experiments continued for 4 hours. The trays were weighed before and after the evaporation run and weight losses, due to mostly water evaporation, were recorded. The solutions in trays after the tests were transferred into 20 mL scintillation glass vials and were submitted to the HPLC analysis for the raspberry ketone content. The raspberry ketone losses are shown in FIG. 11.

Statistically dilutions of adjuvants with 8 wt. % 1-tetradecanol and 4 wt. % 1-hexadecanol were on par regarding the solute volatilization. The other two dilutions, based on 12 wt. % and 16 wt. % 1-tetradecanol, were also statistically similar, but with about 3 times lesser volatilization on the raspberry ketone. This effect is rather important and can be utilized in spraying dilutions over larger surfaces.

### Example 12: Preparation of an Adjuvant

1-Hexadecanol (4.0 g) was added to the methyl decanoate (96.0 g). The resulting mixture was stirred at ambient conditions until a clear homogeneous solution was formed. To accelerate the process the mixture was heated just above the melting point of the alcohol (49.3° C.).

A 4 wt % solution of 2-(hexadecyloxy) ethanol (HDOE) in methyl decanoate was prepared. The 4 wt % HDOE in methyl decanoate solution was diluted 10,000 times with water. The dilution along with pure water were tried on the rate of water evaporation. After 17 h exposure in the fume hood at ambient conditions with air velocity of 4 km/h and 60-65% RH, the water losses (averages of triplicates) were as follows: 58% for pure water, 28% for cetyl alcohol (CA) in methyl decanoate and 15% for HDOE in methyl decanoate. The new adjuvant with HDOE was almost 2 times more efficient in depressing water evaporation than CA adjuvant.

Numerous examples are provided herein to enhance the understanding of the present disclosure. A specific set of embodiments are provided as follows.
Embodiment 1: A liquid composition comprising an organic solute, wherein the organic solute comprises an organic compound with a vapor pressure of less than 0.01 mm Hg, a water-immiscible solvent in an amount from about 0.005% to about 5% by weight of the composition, and an aliphatic water-insoluble alcohol.
Embodiment 2: The liquid composition of embodiment 1, wherein the aliphatic water-insoluble alcohol comprises a primary straight chain alcohol.
Embodiment 3: The liquid composition of embodiment 2, wherein the primary straight chain alcohol comprises a C₁₄-C₁₈ alkanol.
Embodiment 4: The liquid composition of embodiment 2 or embodiment 3, wherein the primary straight chain alcohol is selected from the group consisting of 1-tetradecanol, 1-pentadecanol, 1-hexadecanol, 1-heptadecanol, 1-octadecanol, and combinations thereof.
Embodiment 5: The liquid composition of any one of embodiments 1 to 4, wherein the aliphatic water-insoluble alcohol comprises a 2-(alkyloxy) ethanol, diethylene glycol monoalkyl ethers, tricthylene glycol monoalkyl ethers, or combinations thereof.
Embodiment 6: The liquid composition of embodiment 5, wherein the 2-(alkyloxy) ethanol is selected from the group consisting of 2-(tetradecyloxy) ethanol, 2-(pentadecyloxy) ethanol, 2-(hexadecyloxy) ethanol, 2-(heptadecyloxy) ethanol, 2-(octadecyloxy) ethanol, and combinations thereof.
Embodiment 7: The liquid composition of embodiment 5, the diethylene glycol monoalkyl ether is selected from the group consisting of 2-(2-tetradecyloxyethoxy) ethanol, 2-(2-pentadecyloxyethoxy) ethanol, 2-(2-hexadecyloxyethoxy) ethanol, 2-(2-(heptadecyloxy) ethoxy) ethanol, 2-(2-(octadecyloxy) ethoxy) ethanol, 2-(2-(eicosanyloxy) ethoxy) ethanol, and combinations thereof.
Embodiment 8: The liquid composition of embodiment 5, wherein the triethylene glycol monoalkyl ether is selected from the group consisting of 2-(2-(2-pentadecyloxyethoxy) ethoxy) ethanol, 2-(2-(2-hexadecyloxyethoxy) ethoxy) ethanol, 2-(2-(2-heptadecyloxyethoxy) ethoxy) ethanol, 2-(2-(2-octadecyloxy) ethoxy) ethoxy) ethanol, 2-(2-(2-eicosanyloxy) ethoxy) ethoxy) ethanol, and combinations thereof.
Embodiment 9: The liquid composition of any one of embodiments 1-8, wherein the water-immiscible solvent comprises an ester, amide, ether, ketone, alcohol, alkane, alkene, aldehyde or any combination thereof.
Embodiment 10: The liquid composition of any one of embodiments 1-9, wherein the water-immiscible solvent comprises fatty acid methyl esters, fatty acid ethyl esters, fatty alcohol esters from the group methyl decanoate, octyl acetate, ethyl decanoate, and decyl acetate.
Embodiment 11: The liquid composition of any one of embodiments 1-10, wherein the water-immiscible solvent has a solubility in water of less than 0.5% by weight.
Embodiment 12: The liquid composition of any one of embodiments 1-11, wherein the water-immiscible solvent has a solubility in water of less than 0.2% by weight.
Embodiment 13: The liquid composition of any one of embodiments 1-12, wherein the aliphatic water insoluble alcohol has a solubility in the water-immiscible solvent of about 4% by weight or greater.
Embodiment 14: The liquid composition of any one of embodiments 1-13, wherein the aliphatic water insoluble alcohol has a solubility in the water-immiscible solvent of about 2% or greater.
Embodiment 15: The liquid composition of any one of embodiments 1-14, wherein the water-immiscible solvent has a density of less than 1.0 g/cm³.
Embodiment 16: The liquid composition of any one of embodiments 1-15, wherein the water-immiscible solvent has a boiling point from about 100° C. to about 300° C. at 760 mm Hg.
Embodiment 17: The liquid composition of any one of embodiments 1-16, wherein the water-immiscible solvent has a boiling point from about 140° C. to about 240° C. at 760 mm Hg.
Embodiment 18: The liquid composition of any one of embodiments 1-17, wherein a self-assembled monolayer comprising the aliphatic water-insoluble alcohol is formed on an air/liquid interphase of the liquid composition.
Embodiment 19: The liquid composition of any one of embodiments 1-18, wherein the organic solute is selected from the group consisting of an auxin herbicide, an insect repellant, an insect pheromone, a fragrance, an essential oil, an insecticide, a fungicide, a carboxylic acid, a phenoxy acid, and any combination thereof.
Embodiment 20: The liquid composition of embodiment 19, wherein the auxin herbicide is selected from the group consisting of a natural or synthetic auxin belonging to Group 4 herbicides.
Embodiment 21: The liquid composition of embodiment 19 or embodiment 20, wherein the organic solute is selected from the group consisting of benzoic acid, picolinic acid, a phenoxy acid, and any combination thereof.
Embodiment 22: The liquid composition of any one of embodiments 19-21, wherein the auxin herbicide comprises dicamba, triclopyr, 2,4-dichlorophenoxyacetic acid (2,4-D), or a combination thereof.
Embodiment 23: The liquid composition of any one of embodiments 19-22, wherein the insect repellent comprises N,N-diethyl-meta-toluamide (DEET), icaridin, menthane-3,8-diol, or a combination thereof.
Embodiment 24: The liquid composition of any one of embodiments 1-24, wherein the organic solute comprises a commercially available herbicide.
Embodiment 25: The liquid composition of any one of embodiments 1-26, wherein the liquid composition is a heterogeneous solution.
Embodiment 26: The liquid composition of any one of embodiments 1-25, wherein the liquid composition is an emulsion, suspension, or admixture.
Embodiment 27: The liquid composition of any one of embodiments 1-26, wherein the water-immiscible solvent is present in the liquid composition in an amount from about 0.005% to about 5% by weight of the liquid composition.
Embodiment 28: The liquid composition of any one of embodiments 1-27, wherein the water-immiscible solvent is present in the liquid composition in an amount from about 0.005% to about 0.2% by weight of the liquid composition.
Embodiment 29: The liquid composition of any one of embodiments 1-28, further comprising water.
Embodiment 30: The liquid composition of embodiment 29, wherein the water is distilled or reverse osmosis-purified water.
Embodiment 31: The liquid composition of embodiment 29 or embodiment 30, wherein the water has a conductivity of about 0.01 mS/cm or less.
Embodiment 32: The liquid composition of any one of embodiments 1-31, wherein the aliphatic water-insoluble alcohol is present in an amount from about 4×10⁻⁶% to about 4×10⁻²% by weight of the liquid composition.
Embodiment 33: The liquid composition of any one of embodiments 1-32, further comprising a water-miscible solvent.
Embodiment 34: The liquid composition of embodiment 33, wherein the water-miscible solvent is miscible with the water-immiscible solvent.
Embodiment 35: The liquid composition of embodiment 33, wherein the solubility of the primary straight chain alcohol in the water-miscible solvent is greater than 4%.
Embodiment 36: The liquid composition of embodiment 33, wherein the solubility of the 2-(alkyloxy) ethanol, diethylene glycol monoalkyl ethers, or triethylene glycol monoalkyl ethers in the water-miscible solvent is greater than 4%.
Embodiment 37: The liquid composition of embodiment 33, wherein the water-miscible solvent has a boiling point greater than 140° C.
Embodiment 38: The liquid composition of embodiment 33, wherein the water-miscible solvent comprises dipropylene glycol, propylene glycol, triethylene glycol, furfuryl alcohol, dimethyl sulfoxide, dimethylformamide, dimethylacetamide, n-methyl-2-pyrrolidone, 1,5-pentanediol, 1,6-hexandiol or combinations thereof.
Embodiment 39: The liquid composition of any one of embodiments 2-38, wherein the solubility of the primary straight chain alcohol in the water-immiscible solvent is greater than 4%.
Embodiment 40: The liquid composition of any one of embodiments 5-39, wherein the solubility of the 2-(alkyloxy) ethanol, the diethylene glycol monoalkyl ether, or the triethylene glycol monoalkyl ether in the water-immiscible solvent is greater than 4%.
Embodiment 41: The liquid composition of any one of embodiments 1-40, wherein the water-immiscible solvent has boiling temperature of greater than 140° C.
Embodiment 42: The liquid composition of any one of embodiments 1-41, further comprising an amine-based counterion.
Embodiment 43: A liquid composition comprising an organic solute in an amount from about 30% to about 60% by weight of the liquid composition, a water-miscible solvent in an amount from about 0% to about 25% by weight of the liquid composition, a water-immiscible solvent in an amount from about 0.5% to about 5% by weight of the liquid composition, an aliphatic water-insoluble alcohol in an amount from about 4×10⁻⁴% to about 4% by weight of the liquid composition, and water in an amount from about 0% to about 30% by weight of the liquid composition.
Embodiment 44: The composition of embodiment 43, wherein a self-assembled monolayer comprising the aliphatic water-insoluble alcohol is formed on an air/water interphase of the liquid composition after dilution by 100 times with water.
Embodiment 45: A liquid composition comprising an organic solute in an amount from about 0.3% to about 0.6% by weight of the liquid composition, a water-miscible solvent in an amount from about 0% to about 0.25% by weight of the liquid composition, a water-immiscible solvent in an amount from about 0.005% to about 0.05% by weight of the liquid composition, an aliphatic water-insoluble alcohol in an amount from about 4×10⁻⁶% to about 0.04% by weight of the liquid composition, and water.
Embodiment 46: The liquid composition of embodiment 45, wherein a self-assembled monolayer comprising the aliphatic water-insoluble alcohol is formed on an air/water interphase of the liquid composition.
Embodiment 47: The liquid composition of embodiment 45 and embodiment 46, wherein the water-immiscible solvent comprises an ester, amide, ether, ketone, alcohol, alkane, alkene, aldehyde or any combination thereof.
Embodiment 48: The liquid composition of any one of embodiments 45-47, wherein the water-immiscible solvent comprises methyl decanoate or n-octyl acetate.
Embodiment 49: An adjuvant composition comprising a water-immiscible solvent and an aliphatic water-insoluble alcohol.
Embodiment 50: The adjuvant composition of embodiment 49, wherein the aliphatic water-insoluble alcohol includes at least one of a primary straight chain alcohol in an amount not exceeding the primary straight chain alcohol's solubility limit in the water immiscible solvent, a 2-(alkyloxy) ethanol in an amount not exceeding the 2-(alkyloxy) ethanol's solubility limit in the water immiscible solvent, a diethylene monoalkyl ether in an amount not exceeding the diethylene monoalkyl ether's solubility limit in the water immiscible solvent, or a triethylene glycol monoalkyl ether in an amount not exceeding the triethylene glycol monoalkyl ether's solubility limit in the water immiscible solvent.
Embodiment 51: The adjuvant composition of embodiment 50, wherein the 2-(alkyloxy) ethanol is selected from the group consisting of 2-(tetradecyloxy) ethanol, 2-(pentadecyloxy) ethanol, 2-(hexadecyloxy) ethanol, 2-(heptadecyloxy) ethanol, 2-(octadecyloxy) ethanol, and combinations thereof.
Embodiment 52: The adjuvant composition of embodiment 50, wherein the diethylene glycol monoalkyl ether is selected from the group consisting of 2-(2-tetradecyloxyethoxy) ethanol, 2-(2-pentadecyloxyethoxy) ethanol, 2-(2-hexadecyloxyethoxy) ethanol, 2-(2-(heptadecyloxy) ethoxy) ethanol, 2-(2-(octadecyloxy) ethoxy) ethanol, and combinations thereof.
Embodiment 53: The adjuvant composition of embodiment 50, wherein the triethylene glycol monoalkyl ether is selected from the group consisting of 2-(2-(2-pentadecyloxyethoxy) ethoxy) ethanol, 2-(2-(2-hexadecyloxyethoxy) ethoxy) ethanol, 2-(2-(2-heptadecyloxyethoxy) ethoxy) ethanol, 2-(2-(2-octadecyloxyethoxy) ethoxy) ethanol, and combinations thereof.
Embodiment 54: The adjuvant composition of any one of embodiments 49-53, wherein the aliphatic water-insoluble alcohol is present in an amount from about 1% to about 50% by weight of the adjuvant composition.
Embodiment 55: The adjuvant composition of any one of embodiments 49-54, wherein the aliphatic water-insoluble alcohol is present in an amount from about 10% to about 50% by weight of the adjuvant composition.
Embodiment 56: The adjuvant composition of of any one of embodiments 49-55, wherein the aliphatic water-insoluble alcohol is present in an amount from about 10% to about 20% by weight of the adjuvant composition.
Embodiment 57: The adjuvant composition of of any one of embodiments 50-56, wherein the primary straight chain alcohol comprises a C₁₄-C₁₈ alkanol.
Embodiment 58: The adjuvant composition of any of embodiments 50-57, wherein the primary straight chain alcohol is selected from the group consisting of 1-tetradecanol, 1-pentadecanol, 1-hexadecanol, 1-heptadecanol, 1-octadecanol, and combinations thereof.
Embodiment 59: The adjuvant composition of of any one of embodiments 49-58, wherein the adjuvant composition is a clear solution.
Embodiment 60: The adjuvant composition of any one of embodiments 49-59, wherein the aliphatic water-insoluble alcohol has a solubility in the water-immiscible solvent of no less than 4%.
Embodiment 61: The adjuvant composition of any one of embodiments 49-60, wherein the water-immiscible solvent has a solubility in water of less than 0.2%.
Embodiment 62: The adjuvant composition of any one of embodiments 49-61, wherein the water-immiscible solvent has a density of less than 1.0 g/cm³.
Embodiment 63: The adjuvant composition of any one of embodiments 49-62, wherein the water-immiscible solvent has a boiling point from about 140° C. to about 240° C. at 760 mm Hg.
Embodiment 64: A concentrated solute composition comprising an organic solute in an amount no greater than about 60% by weight of the composition, a water-immiscible solvent, and an aliphatic water-insoluble alcohol.
Embodiment 65: The composition of embodiment 64, wherein the aliphatic water-insoluble alcohol comprises a primary straight chain alcohol.
Embodiment 66: The composition of embodiment 65, wherein the primary straight chain alcohol is present in an amount from about 4×10⁻⁴% to about 4% by weight of the composition.
Embodiment 67: The composition of embodiment 65 or embodiment 66, wherein the primary straight chain alcohol comprises a C₁₄-C₁₈ alkanol.
Embodiment 68: The composition of any one of embodiments 65-67, wherein the primary straight chain alcohol is selected from the group consisting 1-tetradecanol, 1-pentadecanol, 1-hexadecanol, 1-heptadecanol, 1-octadecanol, and combinations thereof.
Embodiment 69: The composition of any one of embodiments 64-68, wherein the aliphatic water-insoluble alcohol comprises a 2-(alkyloxy) ethanol, diethylene glycol monoalkyl ethers, tricthylene glycol monoalkyl ethers, and a combination thereof.
Embodiment 70: The composition of embodiment 69, wherein the 2-(alkyloxy) ethanol is selected from the group consisting of 2-(tetradecyloxy) ethanol, 2-(pentadecyloxy) ethanol, 2-(hexadecyloxy) ethanol, 2-(heptadecyloxy) ethanol, 2-(octadecyloxy) ethanol, and combinations thereof.
Embodiment 71: The composition of any one of embodiments 64-70, wherein the water-immiscible solvent comprises an ester, amide, ether, ketone, alcohol, alkane, alkene, aldehyde or any combination thereof.
Embodiment 72: The composition of any one of embodiments 64-71, wherein the water-immiscible solvent comprises methyl decanoate or octyl acetate.
Embodiment 73: The composition of any one of embodiments 65-72, wherein the primary straight chain alcohol and/or the 2-(alkyloxy) ethanol, the diethylene glycol monoalkyl ethers, and the tricthylene glycol monoalkyl ethers have a solubility in the water-immiscible solvent of no less than 4%.
Embodiment 74: The composition of any one of embodiments 64-73, wherein the water-immiscible solvent has a solubility in water of less than 0.2%.
Embodiment 75: The composition of any one of embodiments 64-74, wherein the water-immiscible solvent has a density of less than 1.0 g/cm³.
Embodiment 76: The composition of any one of embodiments 64-75, wherein the water-immiscible solvent has a boiling point from about 140° C. to about 240° C. at 760 mm Hg.
Embodiment 77: The composition of any one of embodiments 64-76, further comprising a water-miscible solvent.
Embodiment 78: The composition of embodiment 77, wherein the water-miscible solvent is present in a concentration from about 0.5% to about 20% by weight of the composition.
Embodiment 79: The composition of any one of embodiments 64-78, wherein the organic solute is selected from the group consisting of an auxin herbicide, an insect repellant, an insect pheromone, a fragrance, an essential oil, an insecticide, a fungicide, a carboxylic acid, a phenoxy acid, and any combination thereof.
Embodiment 80: The composition of embodiment 79, wherein the auxin herbicide is a natural or synthetic auxin herbicide belonging to Group 4 herbicides.
Embodiment 81: The composition of embodiment 79 or embodiment 80, wherein the auxin herbicide comprises dicamba, triclopyr, 2,4-dichlorophenoxyacetic acid (2,4-D), or any combination thereof.
Embodiment 82: The composition of any one of embodiments 79-81, wherein the insect repellant comprises N,N-diethyl-meta-toluamide (DEET), icaridin, menthane-3,8-diol, or any combination thereof.
Embodiment 83: The composition of any one of embodiments 64-82, wherein the organic solute is selected from the group consisting of benzoic acid, picolinic acid, and any combination thereof.
Embodiment 84: The composition of any one of embodiments 64-83, wherein the organic solute comprises a commercially available herbicide.
Embodiment 85: The composition of any one of embodiments 64-84, wherein the water-miscible solvent comprises dipropylene glycol, propylene glycol, triethylene glycol, furfuryl alcohol, dimethyl sulfoxide, dimethylformamide, dimethylacetamide, n-methyl-2-pyrrolidone, 1,5-pentanediol, 1,6-hexandiol or combinations thereof.
Embodiment 86: A liquid composition comprising an organic solute, wherein the organic solute comprises an organic compound with a vapor pressure of less than 0.01 mm Hg, and a water-miscible solvent.
Embodiment 87: The liquid composition of embodiment 86, wherein the organic solute is selected from the group consisting of an auxin herbicide, an insect repellant, an insect pheromone, a fragrance, an essential oil, an insecticide, a fungicide, a carboxylic acid, a phenoxy acid, and any combination thereof.
Embodiment 88: The liquid composition of embodiment 87, wherein the auxin herbicide is a natural or synthetic auxin herbicide belonging to Group 4 herbicides.
Embodiment 89: The liquid composition of any one of embodiments 87-89, wherein the organic solute is selected from the group consisting of benzoic acid, picolinic acid, and any combination thereof.
Embodiment 90: The liquid composition of any one of embodiments 87-90, wherein the auxin herbicide comprises dicamba, triclopyr, 2,4-dichlorophenoxyacetic acid (2,4-D), or any combination thereof.
Embodiment 91: The liquid composition of any one of embodiments 87-90, wherein the insect repellent comprises N,N-diethyl-meta-toluamide (DEET), icaridin, menthane-3,8-diol, or any combination thereof.
Embodiment 92: The liquid composition of any one of embodiments 86-91, wherein the organic solute comprises a commercially available herbicide.
Embodiment 93: The liquid composition of any one of embodiments 86-92, wherein the water-miscible solvent comprises dipropylene glycol.
Embodiment 94: The liquid composition of any one of embodiments 86-93, wherein the water-miscible solvent is present in a concentration from greater than 0% to about 45% by weight.
Embodiment 95: A method for reducing the volatility of an organic solute, the method comprising combining an adjuvant composition comprising an aliphatic water-insoluble alcohol and a water-immiscible solvent with a liquid composition comprising the organic solute.
Embodiment 96: The method of embodiment 95, wherein the adjuvant composition comprises a water-immiscible solvent and an aliphatic water-insoluble alcohol.
Embodiment 97: The method of embodiment 95 or embodiment 96, wherein the liquid composition is the liquid composition comprises an organic solute and a water-miscible solvent, wherein the organic solute comprises an organic compound with a vapor pressure of less than 0.01 mm Hg.
Embodiment 98: The method of any one of embodiments 95-97, further comprising diluting the combined adjuvant composition and liquid composition with water by at least 100 times.
Embodiment 99: The method of embodiment 98, wherein the water is distilled or reverse osmosis-purified water.
Embodiment 100: The method of embodiment 98 or embodiment 99, wherein the water has a conductivity of about 0.01 mS cm⁻¹ or lower.
Embodiment 101: The method of any one of embodiments 95-100, wherein the combining the adjuvant composition and the liquid composition forms a self-assembled monolayer comprising the aliphatic water-insoluble alcohol on an air/water interphase of the combined adjuvant composition and liquid composition.
Embodiment 102: The method of any one of embodiments 95-101, further comprising spraying the combined adjuvant composition and liquid composition onto a plant.
Embodiment 103: The method of any one of embodiments 95-102, wherein the volatility of the organic solute is reduced as compared to the organic solute dissolved in water alone.
Embodiment 104: The method of any one of embodiments 95-103, wherein the volatility of the organic solute is reduced as compared to the organic solute dissolved in a composition consisting of water and the water-miscible solvent.
Embodiment 105: The method of any one of embodiments 95-104, wherein the volatility of the organic solute is reduced by at least 50%.
Embodiment 106: The method of any one of embodiments 95-105, wherein the volatility of the organic solute is reduced by at least 100%.
Embodiment 107: A method for preventing the volatilization of an organic solute, the method comprising combining an adjuvant composition comprising an aliphatic water-insoluble alcohol and a water-immiscible solvent with a liquid composition comprising the organic solute and water, wherein a self-assembled monolayer comprising the aliphatic water-insoluble alcohol is formed on an air/water interphase of the liquid composition.
Embodiment 108: The method of embodiment 107, wherein the adjuvant composition is the adjuvant composition of any one of embodiments 49-64.
Embodiment 109: The method of embodiment 107 or embodiment 108, wherein the liquid composition is the liquid composition of any one of embodiments 87-95.
Embodiment 110: The method of any one of embodiments 107-109, further comprising diluting the combined adjuvant composition and liquid composition with water by at least 100 times.
Embodiment 111: The method of embodiment 110, wherein the water is distilled or reverse osmosis-purified water.
Embodiment 112: The method of embodiment 110 or embodiment 111, wherein the water has a conductivity of about 0.01 mS cm⁻¹ or lower.
Embodiment 113: The method of any one of embodiments 107-112, further comprising spraying the combined adjuvant composition and liquid composition onto a plant.
Embodiment 114: The method of any one of embodiments 107-113, wherein the volatility of the organic solute is reduced as compared to the organic solute dissolved in water alone.
Embodiment 115: The method of any one of embodiments 107-114, wherein the volatility of the organic solute is reduced as compared to the organic solute dissolved in a composition consisting of water and the water-miscible solvent.
Embodiment 116: The method of any one of embodiments 107-115, wherein the volatility of the organic solute is reduced by at least 50%.
Embodiment 117: The method of any one of embodiments 107-116, wherein the volatility of the organic solute is reduced by at least 100%.
Embodiment 118: The method of any one of embodiments 107-117, wherein the liquid composition further comprises a water-miscible solvent.
Embodiment 119: A method for reducing vapor drift of an organic solute applied to a crop, the method comprising combining an adjuvant composition comprising a aliphatic water-insoluble alcohol and a water-immiscible solvent with a liquid composition comprising the organic solute and water, and spraying the combination onto a crop.
Embodiment 120: The method of embodiment 119, wherein the adjuvant composition is the adjuvant composition of any one of embodiments 47-61.
Embodiment 121: The method of embodiment 119 or embodiment 120, wherein the liquid composition is the liquid composition of any one of embodiments 84-92.
Embodiment 122: A method for reducing drift of an organic solute applied to a crop, the method comprising spraying a liquid composition of any one of embodiments 1-42 onto a crop.
Embodiment 123: The method of embodiment 122, wherein the liquid composition is sprayed in an amount from about 2-20 gallons per acre.
Embodiment 124: A method of forming a self-assembled monolayer on a water/air interphase of a liquid composition, the method comprising combining an adjuvant composition comprising a water-immiscible solvent and an aliphatic water-insoluble alcohol with a liquid composition comprising an organic solute and water, wherein the self-assembled monolayer comprises a primary straight chain alcohol, 2-(alkyloxy) ethanol, diethylene glycol monoalkyl ethers, triethylene glycol monoalkyl ethers, and any combination thereof.

1. A liquid composition comprising:
an organic solute, wherein the organic solute comprises an organic compound with a vapor pressure of less than 0.01 mm Hg;
a water-immiscible solvent in an amount from about 0.005% to about 0.05% by weight of the composition; and
an aliphatic water-insoluble alcohol in an amount from about 4.0×10⁻⁶% to about 0.04% by weight of the composition.

2. The liquid composition of claim 1, wherein the aliphatic water-insoluble alcohol comprises a primary straight chain alcohol.

3. The liquid composition of claim 2, wherein the primary straight chain alcohol comprises a C₁₄-C₁₈ alkanol.

4. The liquid composition of claim 3, wherein the primary straight chain alcohol is selected from the group consisting of 1-tetradecanol, 1-pentadecanol, 1-hexadecanol, 1-heptadecanol, 1-octadecanol, and combinations thereof.

5. The liquid composition of claim 1, wherein the aliphatic water-insoluble alcohol comprises a 2-(alkyloxy) ethanol, diethylene glycol monoalkyl ethers, triethylene glycol monoalkyl ethers, or combinations thereof.

6. The liquid composition of claim 5, wherein the 2-(alkyloxy) ethanol is selected from the group consisting of 2-(tetradecyloxy) ethanol, 2-(pentadecyloxy) ethanol, 2-(hexadecyloxy) ethanol, 2-(heptadecyloxy) ethanol, 2-(octadecyloxy) ethanol, and combinations thereof.

7. The liquid composition of claim 5, the diethylene glycol monoalkyl ether is selected from the group consisting of 2-(2-tetradecyloxyethoxy) ethanol, 2-(2-pentadecyloxyethoxy) ethanol, 2-(2-hexadecyloxyethoxy) ethanol, 2-(2-(heptadecyloxy) ethoxy) ethanol, 2-(2-(octadecyloxy) ethoxy) ethanol, and 2-(2-(eicosanyloxy) ethoxy) ethanol, and combinations thereof.

8. The liquid composition of claim 5, wherein the triethylene glycol monoalkyl ether is selected from the group consisting of 2-(2-(2-pentadecyloxyethoxy) ethoxy) ethanol, 2-(2-(2-hexadecyloxyethoxy) ethoxy) ethanol, 2-(2-(2-heptadecyloxyethoxy) ethoxy) ethanol, 2-(2-(2-octadecyloxyethoxy) ethoxy) ethanol, 2-(2-(2-eicosanyloxy) ethoxy) ethoxy) ethanol and combinations thereof.

9. The liquid composition of claim 1, wherein the water-immiscible solvent comprises an ester, amide, ether, ketone, alcohol, alkane, alkene, aldehyde or any combination thereof.

10. The liquid composition of claim 9, wherein the water-immiscible solvent comprises fatty acid methyl esters, fatty acid ethyl esters, or fatty alcohol esters.

11. The liquid composition of claim 1, wherein the water-immiscible solvent has a solubility in water of less than 0.5% by weight.

12. The liquid composition of claim 1, wherein the aliphatic water-insoluble alcohol has a solubility in the water-immiscible solvent of 4% by weight or greater.

13. The liquid composition of claim 1, wherein the water-immiscible solvent has a density of less than 1.0 g/cm³.

14. The liquid composition of claim 1, wherein the water-immiscible solvent has a boiling point from about 100° C. to about 300° C. at 760 mm Hg.

15. The liquid composition of claim 1, wherein a self-assembled monolayer comprising the aliphatic water-insoluble alcohol is formed on an air/liquid interphase of the liquid composition.

16. The liquid composition of claim 1, wherein the organic solute is selected from the group consisting of an auxin herbicide, an insect repellent, an insect pheromone, a fragrance, an essential oil, an insecticide, a fungicide, a carboxylic acid, a phenoxy acid, and any combination thereof.

17. The liquid composition of claim 16, wherein the auxin herbicide is selected from the group consisting of a natural or synthetic auxin belonging to Group 4 herbicides.

18. The liquid composition of claim 16, wherein the organic solute is selected from the group consisting of benzoic acid, picolinic acid, a phenoxy acid, and any combination thereof.

19. The liquid composition of claim 16, wherein the auxin herbicide comprises dicamba, triclopyr, 2,4-dichlorophenoxyacetic acid (2,4-D), or a combination thereof.

20. The liquid composition of claim 16, wherein the insect repellent comprises N, N-diethyl-meta-toluamide (DEET), icaridin, menthane-3,8-diol, or a combination thereof.

21. (canceled)

22. The liquid composition of claim 1, wherein the water-immiscible solvent is present in the liquid composition in an amount from about 0.005% to about 0.2% by weight of the liquid composition.

23. The liquid composition of claim 1, further comprising water.

24. The liquid composition of claim 23, wherein the water is distilled or reverse osmosis-purified water.

25. The liquid composition of claim 1, further comprising a water-miscible solvent.

26. An adjuvant composition comprising:
a water-immiscible solvent; and
an aliphatic water-insoluble alcohol.

27. The adjuvant composition of claim 26, wherein the aliphatic water-insoluble alcohol includes at least one of:
a primary straight chain alcohol in an amount not exceeding the primary straight chain alcohol's solubility limit in the water-immiscible solvent;
a 2-(alkyloxy) ethanol in an amount not exceeding the 2-(alkyloxy) ethanol's solubility limit in the water-immiscible solvent
a diethylene glycol monoalkyl ether in an amount not exceeding the diethylene monoalkyl ether's solubility limit in the water; or
a triethylene glycol monoalkyl ether in an amount not exceeding the triethylene glycol monoalkyl ether's solubility limit in the water.

28. The adjuvant composition of claim 26, wherein the aliphatic water-insoluble alcohol is present in an amount from about 1% to about 50% by weight of the adjuvant composition.

29. A method for reducing the volatility of an organic solute, the method comprising:
combining an adjuvant composition comprising an aliphatic water-insoluble alcohol and a water-immiscible solvent with a liquid composition comprising the organic solute.

30. A method for reducing vapor drift of an organic solute applied to a crop, the method comprising:
combining an adjuvant composition comprising an aliphatic water-insoluble alcohol and a water-immiscible solvent with a liquid composition comprising the organic solute and water; and
spraying the combination onto a crop.

31. The liquid composition of claim 9, wherein the water-immiscible solvent comprises methyl decanoate, octyl acetate, ethyl decanoate, or decyl acetate.
